(19) United States
(12) Patent Application Publication
(10) Pub. No.: US 2014/0310058 A1
(43) Pub. Date: Oct. 16, 2014

(54) Identifying Influential and Susceptible Members of Social Networks

(71) Applicant: New York University, New York, NY (US)

(72) Inventors: Sinan Aral, New York, NY (US); Dylan Walker, Hansen, CT (US)

(21) Appl. No.: 14/356,340

(22) PCT Filed: Nov. 6, 2012
(86) PCT No.: PCT/US2012/063675

§ 371 Date: May 5, 2014

Related U.S. Application Data
(60) Provisional application No. 61/556,451, filed on Nov. 7, 2011.
(60) Provisional application No. 61/661,934, filed on Jun. 20, 2012.

(51) Int. Cl. G06Q 30/02; G06Q 50/00

(52) U.S. Cl. CPC G06Q 30/0201; G06Q 30/0269; G06Q 50/01
USPC 705/7.29

(57) ABSTRACT

Methods, systems, and apparatuses, including computer programs encoded on computer readable media, for generating a message associated with a user, wherein the user is associated with a plurality of peers in a social network. A subset of peers is randomly chosen from the plurality of peers. The message is sent to the subset of peers. Data pertaining to one or more behaviors from one or more peers of the plurality of peers is collected. A time for a target behavior is evaluated as a function of who received the message and who did not receive the message. From the evaluation, particular members of the social network are identified.

### CROSS-REFERENCE TO RELATED APPLICATIONS

This application claims the benefit of U.S. Provisional Application No. 61/556,451, filed Nov. 7, 2011, and U.S. Provisional Application No. 61/661,934, filed Jun. 20, 2012, each of which is incorporated by reference herein in its entirety.

### GOVERNMENT RIGHTS

This invention was made with government support under CAREER Award No. 0953832 awarded by the National Science Foundation. The government has certain rights in the invention.

### BACKGROUND

Peer effects are empirically elusive in the social sciences. Scholars in disciplines as diverse as economics, sociology, psychology, finance and management are interested in whether children's peers influence their education outcomes, whether workers' colleagues influence their productivity, whether happiness, obesity and smoking are ‘contagious’ and whether risky behaviors spread as a result of peer-to-peer influence. Answers to these questions are critical to policy because the success of intervention strategies in these domains depends on the robustness of estimates of the degree to which contagion is at work during a social epidemic. Robust estimation of peer effects is also critical to understanding whether new social media technologies magnify peer influence in product demand, voter turnout, and political mobilization or protest.

Unfortunately, identifying peer effects is difficult because estimation is confounded by homophily, simultaneity, correlated effects and other factors. Recent scientific debates about the veracity of a series of high profile networked contagion studies highlight both the difficulty and the importance of separating influence from confounding factors in networked data on social epidemics. Though some new methods separate peer influence from homophily and confounding factors in observational data, controlling for unobservable factors such as latent homophily remains difficult without exogenous variation in adoption probabilities across individuals. Fortunately, randomized experiments provide a more robust means of identifying causal peer effects in networks.

One hypothesis in the peer effects literature is the “influentials” hypothesis—the notion that influential individuals catalyze the diffusion of opinions, behaviors, innovations and products in society. Though this argument has popular appeal, a variety of theoretical models suggest that susceptibility, not influence, is the key trait that drives social contagions. Unfortunately, little empirical evidence exists to adjudicate these claims. Understanding whether influence, susceptibility to influence, or a combination of the two drives social contagions, and accurately identifying influential and susceptible individuals in social networks, could enable new behavioral interventions that promote or contain the spread of behaviors and outcomes such as obesity, smoking, exercise, fraud and the adoption of new products and services.

### SUMMARY

In general, one aspect of the subject matter described in this specification can be embodied in methods for generating a message associated with a user, wherein the user is associated with a plurality of peers in a social network. A subset of peers is randomly chosen from the plurality of peers. The message is sent to the subset of peers. Data pertaining to one or more behaviors from one or more peers of the plurality of peers is collected. A time for a target behavior is evaluated as a function of who received the message and who did not receive the message. From the evaluation, particular members of the social network are identified. Other implementations of this aspect include corresponding systems, apparatuses, and computer-readable media, configured to perform the actions of the method.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 illustrates a system for identifying influential and susceptible members of social networks in accordance with an illustrative implementation.

FIG. 2 shows a comparison of the demographics of a recruited user population as well as of peers of recruited users to the published demographics of a social networking site in accordance with an illustrative implementation.

FIG. 3 illustrates the procedure to randomize the delivery targets of automated notifications in accordance with an illustrative implementation.

FIG. 4 illustrates the effects of age, gender, and relationship status on influence and susceptibility to influence based upon experimental data in accordance with an illustrative implementation.

FIG. 5 illustrates the results of dyadic influence models involving age, gender and relationship status, including the relative age of senders and potential recipients, gender similarity, and the relative commitment level of the relationship status between sender and recipient pairs based upon experimental data in accordance with an illustrative implementation.

FIG. 6A displays the hazard ratio for individuals to adopt spontaneously as function of their attributes based upon experimental data in accordance with an illustrative implementation.

FIG. 6B displays the hazard ratio for individuals to have local network peers adopt spontaneously as function of their attributes based upon experimental data in accordance with an illustrative implementation.

FIG. 7 displays hazard ratios associated with spontaneous peer adoption as a function of the dyadic relationship between message senders and recipients based upon experimental data in accordance with an illustrative implementation.

FIG. 8 illustrates the joint distributions of ego influence and susceptibility based upon the experimental data in accordance with an illustrative implementation.

FIG. 9 illustrates ego influence and peer susceptibility based upon the experimental data in accordance with an illustrative implementation.

FIG. 10 illustrates ego influence and peer influence based upon the experimental data in accordance with an illustrative implementation.

FIG. 11 illustrates ego susceptibility and peer susceptibility based upon the experimental data in accordance with an illustrative implementation.

FIG. 12 illustrates susceptibility estimates based upon the experimental data in accordance with an illustrative implementation.

FIG. 13 illustrates dyadic models with and without frailty based upon the experimental data in accordance with an illustrative implementation.

FIG. 14 is a plot of component+Martingale residuals vs. number of notifications received for influence and susceptibility based upon the experimental data in accordance with an illustrative implementation.

FIG. 15 is a plot of component+Martingale residuals vs. number of notifications received for dyadic peer-to-peer influence based upon the experimental data in accordance with an illustrative implementation.

FIGS. 16A and 16B are residual plots for representative model covariates of the 45 model covariates in the influence and susceptibility model in accordance with an illustrative implementation.

FIGS. 17A and 17B are plots of dfbeta residuals for representative covariates of the 45 covariates in the influence and susceptibility Cox proportional hazard model in accordance with an illustrative implementation.

FIGS. 18A and 18B are residual plots for representative model covariates of the 45 model covariates in the dyadic peer-to-peer influence model in accordance with an illustrative implementation.

FIGS. 19A and 19B are plots of dfbeta residuals for representative covariates of the 23 covariates in the dyadic peer-to-peer influence Cox proportional hazard model in accordance with an illustrative implementation.

FIG. 20 illustrates a flow diagram of a process for identifying particular members of a social network in accordance with an illustrative implementation.

FIG. 21 is a block diagram of a computer system in accordance with an illustrative implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

This specification describes methods, systems, etc., for identifying the level of influence exerted by individuals on their peers, the susceptibility of peers to influence individuals in social networks and the dyadic pathways over which influence is more likely to flow in social networks. The methods, systems, etc., can also identify influential and susceptible members of social networks while avoiding known biases in traditional estimates of social contagion by leveraging large-scale in vivo randomized experiments. In one implementation, estimates of influence and susceptibility to influence in consumer demand for a commercial product distributed using social networks can be determined. Various other implementations can be used to measure influence and susceptibility in the diffusion of products and behaviors in a variety of settings where communication and influence can be mediated and outcome responses are measurable, as is the case in a variety of online systems and intervention programs studied in economics and the social sciences.

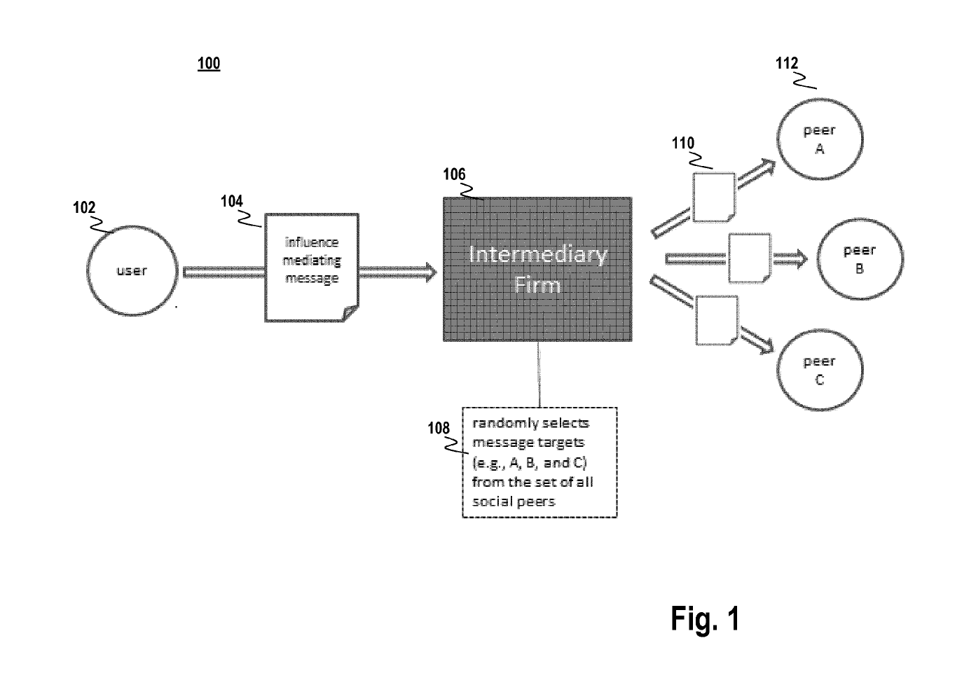

FIG. 1 illustrates a system for identifying influential and susceptible members of social networks in accordance with an illustrative implementation. A user or individual of a social media network 102 can do some activity that results in a message 104 being generated. For example, a user can rate a movie and a message indicating that the user 102 rated the particular movie can be generated. An intermediary firm 106 can receive this message 104 or an indication of the activity in order to generate a message and in response, randomly select message targets from a set of peers of the user 108. For example, the set of peers can be the friends of the user 102 in the social media network. The randomization of message targets performed by the intermediary firm-controlled system (IFCS) is used to separate the effect of influence from other confounding factors (such as selection bias in peer message targets and correlated preferences linked to spontaneous adoption behavior). Target randomization allows peers of the same individual to differ only on whether or not they received an influence-mediating message. An IFCS can be used for other types of treatment randomization. For example, it could modify the content of messages sent from an individual to her peer/s, randomly alter the timing of when messages are delivered to peers, randomly block messages sent from an individual to her peer/s, or to alter the recipient of a message sent from an individual to a peer of their designation. The intermediary firm 106 can also record social network relationships, individual attributes, and the subsequent response to receiving or not receiving influence-mediating messages. The message 104 or an altered message can then be sent 110 to the randomly selected message targets or peers 112.

To estimate the moderating effects of an individual i's attributes on the influence they exert on their peer j and to distinguish them from the moderating effects of j's attributes on j's susceptibility to influence, a survival model can be used. One example of a survival model is a continuous-time single-failure proportional hazards model. Survival models, which account for time to peer adoption, provide information about how quickly peers respond (rather than simply whether they response) and correct for censoring of peer responses that may occur beyond the experiment's observation window. In one implementation, the following model can be used:

λⱼ(t,Xᵢ,Xⱼ,Nⱼ)=λ₀(t)exp(Nⱼ(t)β_{N}+Xᵢβ_{Spont}ⁱ+Xⱼβ_{Spont}^{j}+Nⱼ(t)Xᵢβ_{Infl}+Nⱼ(t)Xⱼβ_{Susc})

where λⱼ is the hazard of peer j of an application user i adopting the application (in the above model each peer j is associated with one and only one application user i), λ₀(t) represents the baseline hazard, Xᵢ represents a set of individual attributes of an application user i, Xⱼ represents a set of individual attributes of peer j. In other models, a peer j can be associated with more than one application user i. Nⱼ(t) represents the number of automated notifications received by a peer j of application user i, as a function of time. Nⱼ(t) reflects the extent to which j has been exposed to influence mediating messages from their friend, e.g., the associated application user. β_{Spont}ⁱ estimates the propensity of an application user with attributes Xᵢ to gain spontaneous adopters in their local network. It captures the tendency for peers to spontaneously adopt in the absence of influence (Nⱼ=0) as a consequence of being friends with someone with the original application user's attributes. β_{Spont}^{j} estimates the propensity for a peer j with attributes Xⱼ to spontaneously adopt. It captures the tendency for a peer to adopt spontaneously in the absence of influence (Nⱼ=0). β_{Infl} estimates the impact of an application user's attributes on their ability to influence their peer to adopt the application above and beyond the peer's attributes on her likelihood to adopt due to influence above and beyond their propensity to adopt spontaneously (alternative specifications, robustness and goodness of fit are described in greater detail below).

Statistical hazard models can be employed to simultaneously estimate spontaneous and influence-driven response to treatment. Spontaneous response is a peer response due to natural proclivity or preferences. Influence-driven response is a peer's response due to influence. Because the IFCS ensures that treatment is randomized, populations of treated and untreated individuals differ only by treatment status. Statistical estimation can be performed through hazard models such as the Cox Proportional Hazards Model (but may be extended to include parametric hazard models or accelerated failure time models) of the general form:

λ(t,X,T)=λ₀(t)exp(Tβ_{T}+Xβ_{Spont}+TXβ_{Inf})

Where λ may be the estimated hazard of an individual to adopt or to have a particular peer adopt; T is a treatment variable indicating whether or not the individual was treated (e.g., received an influence-mediating message) or had a particular peer that was treated (e.g., had a peer receive an influence-mediating message on their behalf); X is a vector of individual or peer attributes (e.g., gender, age, relationship status, product preferences, etc.).

Once the impact of hazard on influence has been statistically estimated in the models specified above (in the context of a given product or service), predictions for out-of-sample users with any combination of individual attributes can be calculated, according to the formula:

$${S}_{Infl} = {\prod }_{a} exp ( {β}_{Infl , a} )$$

Where alpha is a particular individual binary, ordinal, or continuous attribute (such as age or gender). For example, the predicted influence score for a 25 year old single male is given by:

S_{Infl}=exp(β_{Infl,Age25})*exp(β_{Infl,Male})*exp(β_{Infl,Single})

In addition, with knowledge of the network structure for larger populations, profiles of the clustering likelihood of influential or susceptible users can be identified and used to shape or gauge policy (such as advertising efforts, or peer-to-peer interventions), or estimate the extent to which the product will diffuse through the population.

As described above, in various implementations several known sources of bias in influence identification are avoided by randomly manipulating who receives influence-mediating messages. Various implementations also avoid selection bias in who senders choose to send messages to by randomizing whether and to whom influence-mediating messages are sent. For example, in uncontrolled environments users may choose to send messages to peers who they believe are more likely to like the product or are more likely to listen to their advice. This non-random selection confounds estimates of susceptibility to influence by over sampling recipients who are more likely to respond positively to influence. Randomization can avoid this selection bias by delivering messages to those who in expectation are equally likely to respond positively to influence mediating messages. In addition, various implementations can eliminate bias created by homophily or assortativity in networks, the tendency for individuals to choose friends with similar tastes and preferences. When targets of potentially influential communications are randomized amongst peers of the same application user, any homophilous structure between an application user and her peers is identical in expectation for treated and untreated groups of peers. Even latent homophily can be controlled because similarity in unobserved attributes will also be equally represented in treated and untreated peer groups that are chosen at random. Various implementations can also control for unobserved confounding factors because randomly chosen peers are equally likely to be exposed to external stimuli that encourage adoption such as advertizing campaigns or promotions. In some implementations, automatically generated messages can include identical information, eliminating heterogeneity in message content and valence which are known to impact responses to social influence. Other unobserved factors that could potentially drive influence, such as offline communications between peers, are also held constant because treated and untreated peers in expectation share similar propensities to receive and be affected by such communications on average. Differences in adoption outcomes between treated and untreated peer groups can then be attributed solely to their treatment status, namely, whether or not they received a notification. Finally, models of dyadic relationships between influencers and potential susceptibles test whether influence-based diffusion depends on dyadic characteristics of the relationship between influencers and those being influenced, rather than simply whether some people are generally more influential than others.

In one implementation, the statistical approach that can be used is hazard modeling, which is the standard technique for estimating social contagion in economics, marketing, and sociology literatures. However, existing techniques can be extended to distinguish and simultaneously estimate two types of peer adoption: spontaneous adoption—peer adoption that occurs spontaneously even in the absence of influence, and influence-driven adoption—peer adoption that occurs in response to persuasive messages. This extension is important because adoption outcomes cluster among peers even in the absence of influence as a consequence of endogeneity, homophily, simultaneity and correlated effects. In one implementation, three distinct hazard models can be used to measure the moderating effect of individual attributes on influence, susceptibility to influence and dyadic peer-to-peer influence between user-peer pairs. These analyses estimate the extent to which specific individual characteristics drive influence, susceptibility to influence and the dyadic pathways over which influence is most likely to travel.

To estimate the moderating effects of individual attributes on the influence someone exerts on her peers, the following continuous-time single-failure proportional hazards model can be used:

λ(t,Xᵢ,Nⱼ)=λ₀(t)exp(Nⱼβ_{N}+Xᵢβ_{Spont}+NⱼXₜβ_{Infl})

where λ is the hazard of an application user i gaining a peer adopter in her local network, λ₀(t) represents the baseline hazard, Xᵢ represents a vector of individual attributes of an application user i, and Nⱼ the number of automated notifications received by a peer j of application user i. β_{N} estimates the average treatment effect of receiving a notification on the likelihood of peer adoption, irrespective of the attributes of the sender. β_{Spont} estimates the propensity of an application user with attributes Xᵢ to gain spontaneous adopters in her local network. It captures the tendency for peers to spontaneously adopt in the absence of influence (Nⱼ=0) as a consequence of being friends with someone with the original application user's attributes. β_{Infl} estimates the impact of an application user's attributes on her ability to influence her peer to adopt the application above and beyond the peer's propensity to adopt spontaneously. It captures the moderating effect of application users' attributes on the marginal influence of their notifications on their peers' adoption hazard.

To estimate the effect of a peer's attributes on their susceptibility to influence, the following continuous-time single-failure proportional hazards model can be used:

λ(t,Xⱼ,Nⱼ)=λ₀(t)exp(Nⱼβ_{N}+Xⱼβ_{Spont}+NⱼXⱼβ_{Susc})

where λ is the hazard associated with a peer's probability to adopt, λ₀(t) represents the baseline hazard, Xⱼ represents a vector of individual attributes of peer j, and Nⱼ represents the number of automated notifications a peer received. β_{Spont} estimates the propensity for a peer j with attributes Xⱼ to spontaneously adopt. It captures the tendency for a peer to adopt spontaneously in the absence of influence (Nⱼ=0). β_{Susc} estimates the impact of a peer's attributes on his likelihood to adopt due to influence above and beyond his propensity to adopt spontaneously.

In another implementation, the above two equations can also be combined and the model specified as:

λⱼ(t,Xᵢ,Xⱼ,Nⱼ)=λ₀(t)exp(Nⱼ(t)β_{N}+Xᵢβ_{Spont}ⁱ+Xⱼβ_{Spont}^{j}+Nⱼ(t)Xᵢβ_{Infl}+Nⱼ(t)Xⱼβ_{Susc})

Finally, to estimate the effect of dyadic relationships between senders' and recipients' attributes on the likelihood of a sender influencing a recipient to adopt, the following continuous-time single-failure proportional hazards model can be used:

λⱼ(t,Xᵢ,Xⱼ,Nⱼ)=λ₀(t)exp(Nⱼ(t)β_{N}+S(Xᵢ,Xⱼ)β_{Spont}^{i-j}+Nⱼ(t)S(Xᵢ,Xⱼ)β_{Infl}^{i-j})

where Xᵢ represents a vector of the individual attributes of the sender, Xⱼ represents a vector of the individual attributes of peer j (the potential recipient), and S(Xᵢ,Xⱼ) represents a vector of dyadic covariates that characterize the joint attributes of the sender-recipient pair. Dyadic covariates estimate for example whether influence is stronger when the sender and recipient are of the same or different genders or when the sender is older or younger than the recipient. β_{Spont} estimates the effect of a shared dyadic relationship between an application user i and her peer j on the tendency for the peer to adopt spontaneously. For example, when the dyadic relationship variable is an indicator of similarity (such as same age), β_{Spont} captures the extent to which similarity on that dimension predicts the likelihood to spontaneously adopt, and represents the propensity to adopt due to preference similarity and other explanations for correlations in adoption likelihoods between peers that are not a result of influence. β_{Infl} then estimates the effect of the dyadic relationship attribute (e.g. same age) on the degree to which a sender influences her recipient peer to adopt, above and beyond their likelihood to spontaneously adopt.

The described method/system can be understood more readily by reference to the following example, which is provided by way of illustration and is not intended to be limiting in any way. An example system was implemented using a social networking site. The example system included an application that allowed users to share information and opinions about movies, actors, directors and the film industry in general. The application was made publicly available to users of the social network. As users adopted and used the product, automated broadcast notifications of their activities were delivered to randomly selected peers in their local social networks. For example, when a user rated a new movie on the application, a randomly selected subset of their social networking friends was sent a message indicating that their peer had rated a movie using this product with a link to the canvas page describing the product and instructions on how to adopt it. Such messages randomly spread awareness of the product and adopters' use of the product to their peers. Since message recipients were randomly selected, treated peers only differed from non-treated peers of the same application user by their treatment status—whether or not they received messages. The experiment was conducted over a 44-day period during which 7730 product adopters sent 41,686 automated notifications to randomly chosen targets amongst their 1.3 million friends, resulting in 976 peer adoptions or a 13% increase in demand for the product. The randomization took place at the level of the local ego network, meaning that messages were randomized across the peers of every adopting user such that each peer of an adopting user had the same likelihood of receiving a randomized automated notification. Tables A1-A3 display descriptive statistics for the number of notifications sent and received by application users and their peers, respectively, and the subsequent adoption response according to age, gender and relationship status.

TABLE A1
Descriptive Statistics of User and Peer Demographics

| | Number of Users | Number of Peers |
|---|---|---|
| Age 0-18 | 458 | 63,063 |
| Age 18-23 | 343 | 65,606 |
| Age 23-31 | 439 | 62,176 |
| Age 31+ | 959 | 69,100 |
| Age Unreported | 5,531 | 1,036,257 |
| Male | 867 | 134,866 |
| Female | 1,867 | 172,406 |
| Gender Unreported | 4,996 | 988,930 |
| Single | 513 | 65,410 |
| In a Relationship | 255 | 39,536 |
| Engaged | 70 | 9,494 |
| Married | 485 | 33,561 |
| Complicated | 38 | 4,775 |
| Relationship Unreported | 6,369 | 1,143,426 |

Notes:
The table reports the descriptive statistics concerning the demographic distributions of user and peer attributes for gender, age, and relationship status.

TABLE A2
Descriptive Statistics of Peer Adoption Response in Local
Networks of Users

| | Number of | Average Number | Average Number |
|---|---|---|---|
| | Notifications | of Adopters in | of Adopters per |
| | Sent | Local Network | Notification Sent |
| Age 0-18 | 2,581 | 0.1659 | 6.43e−5 |
| Age 18-23 | 1,339 | 0.0875 | 6.53e−5 |
| Age 23-31 | 1,381 | 0.0661 | 4.79e−5 |
| Age 31+ | 3,486 | 0.0885 | 2.54e−5 |
| Male | 3,005 | 0.0853 | 2.83e−5 |
| Female | 8,700 | 0.1050 | 1.21e−5 |
| Single | 2,805 | 0.1520 | 5.42e−5 |
| In a Relationship | 1,551 | 0.1176 | 7.58e−5 |
| Engaged | 667 | 0.1143 | 1.71e−4 |
| Married | 2,481 | 0.1052 | 4.24e−5 |
| Complicated | 430 | 0.1842 | 4.28e−4 |

Notes:
The table reports the descriptive statistics concerning number of notifications sent by application users and the peer adoption response in the local networks of users according to user's gender, age, and reported relationship status.

TABLE A3
Descriptive Statistics of Peer Adoption

| | | | Average Number |
|---|---|---|---|
| | Number of | | of Adopting Peers |
| | Notifications | Number of Peers | per Notification |
| | Received | Who Adopted | Received |
| Age 0-18 | 2,641 | 91 | 3.45e−2 |
| Age 18-23 | 2,534 | 69 | 2.72e−2 |
| Age 23-31 | 2,388 | 43 | 1.80e−2 |
| Age 31+ | 3,619 | 117 | 3.23e−2 |
| Male | 6,065 | 140 | 2.31e−2 |
| Female | 8,422 | 267 | 3.17e−2 |
| Single | 1,797 | 96 | 5.34e−2 |
| In a Relationship | 1,243 | 40 | 3.22e−2 |
| Engaged | 303 | 9 | 2.97e−2 |
| Married | 1,086 | 56 | 5.16e−2 |
| Complicated | 153 | 4 | 2.61e−2 |

Notes:
The table reports the descriptive statistics concerning number of notifications received by peers and the resulting response according to peer's gender, age, and reported relationship status.

Table A1 reports demographic distributions of user and peer attributes for gender, age, and relationship status. The first column of Tables A2 and A3 report the number of notifications sent by users to their local network peers and the number of notifications received by peers according to age, gender and relationship status attributes. The number of notifications sent by a user to his peers is a function of their application activity and limitations on the maximum number of notifications sent set by the policy of the social networking site. An examination of these statistics reveals that female application users sent more than 2.5 times as many notifications as males. Users that reported their relationship status as “Single” sent the most notifications, followed by “Married,” “In a Relationship,” “Engaged,” “It's Complicated,” in descending order. While recipient targets of notifications are randomized at the ego network level, the number of notifications received by a peer is a function of the application activity of the peer's adopter friend (the application user). Although each peer of an application user has the same expected probability of receiving a notification, the number of notifications received by peers of an application user may depend on correlations between the application user's attributes and the attributes of their peers. For example, male users may tend to have more female peers (a heterophilous structure) making women more likely to receive notifications from men on aggregate. As Table A2 column 1 indicates, female peers received on average 130% more notifications than male peers. Peers that reported their relationship status as “Single” received the most notifications, followed by “In a Relationship,” “Married,” “Engaged,” and “It's Complicated” in descending order. The randomization procedure and subsequent analysis control for such systematic correlations was done by randomly distributing notifications to target peers of the same application user and controlling for the number of notifications received by peers.

To reach users of the social network, an advertising campaign was used. The advertisements of the campaign, were displayed such that the likelihood that the recruited population was a representative sample of the social network population was maximized. Advertisements were subsequently displayed to users through advertising space within the social network. The advertising campaign resulted in 7,730 usable experimental subjects. The campaign was conducted in three waves throughout the duration of the experiment to recruit a population of experimental subjects that consisted of 7,730 application users and 1.3M distinct peers. Of the 8,910 advertising related installations of the application, 7,730 users continued to fully install and use the application sufficiently to grant permission for the application to send notifications on their behalf. The application was also publically listed in social network's application directory and so was available to anyone on the social network. Details of the campaign are displayed in Table A4.

TABLE A4
Recruitment Statistics Describing the Initial Advertising
Campaign

| | | | Advertising | |
|---|---|---|---|---|
| | | | Related | |
| Wave | Impressions | Clicks | Installations | Installations |
| 1 (Day 0) | 18,264,600 | 12,334 | 3,072 | 3,714 |
| 2 (Day 15) | 20,912,880 | 25,709 | 2,619 | 3,474 |
| 3 (Day 20) | 19,957,640 | 7,624 | 3,219 | 4,039 |
| Total | 59,135,120 | 45,667 | 8,910 | 11,227 |

While the steps outlined above were taken to ensure that application users and their peers were as representative of the social network population as possible, the analysis and influence estimates do not depend upon recruiting a fully representative sample. While deviations of the demographics of application users and their peers from the larger population may introduce more variance (and thus wider confidence intervals) in estimates of influence, susceptibility to influence and spontaneous adoption hazards for underrepresented demographic categories, estimates of the coefficients themselves are not subject to any systematic bias because randomization eliminates any selection effects. Nonetheless, all demographic categories are well represented in the population of application users and their peers and compare this population to the best available data on the social network population demographics to test the representativeness of the sample to the larger social network population.

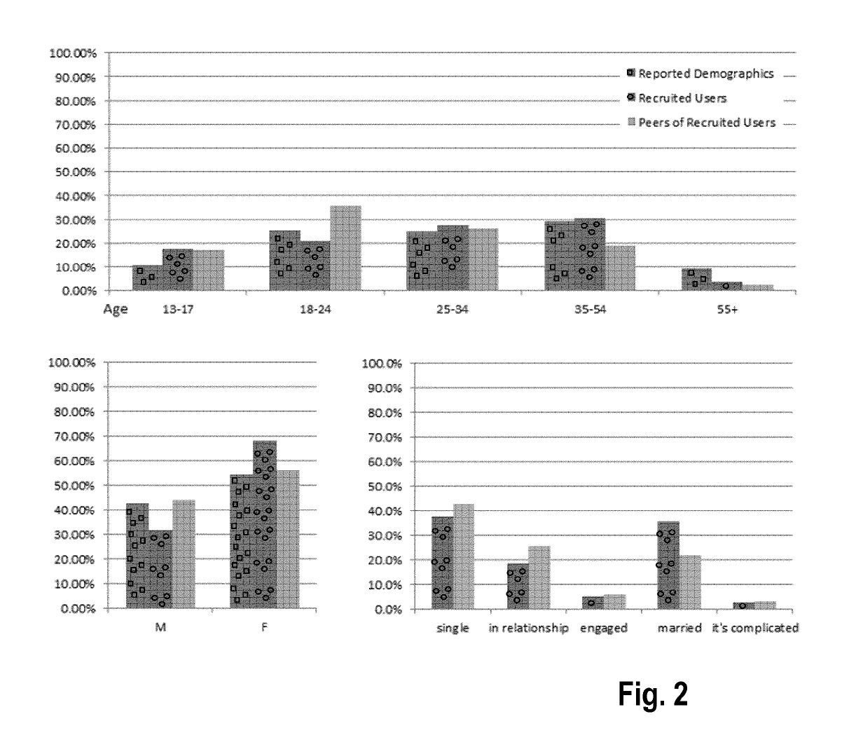

The social network does not publish or make available any official data regarding the demographics of its user population, however, basic demographics of age and gender were compared to a recent report published online by istrategylabs.com, a social targeting advertisement service. FIG. 2 shows a comparison of the demographics of the recruited user population as well as of peers of recruited users to the published demographics. The demographics of users in this sample study were generally representative of the social network's population at the time the study was conducted, and the published demographics fall within one standard deviation of study's population sample means. Peers of recruited users are also well represented across demographic categories, though the peer population sample has more individuals in the 18-24 age range, less individuals in the 35-54 age range, and is more representative of the broader population in terms of the gender distribution than the population of recruited users.

In the sample study, the sample application displayed messages in a user's notification inbox, where a user can view and click on notifications delivered to their inbox. The notification inbox is private and only visible to users logged into the social networking site. It is not visible to peers visiting other user's profile pages.

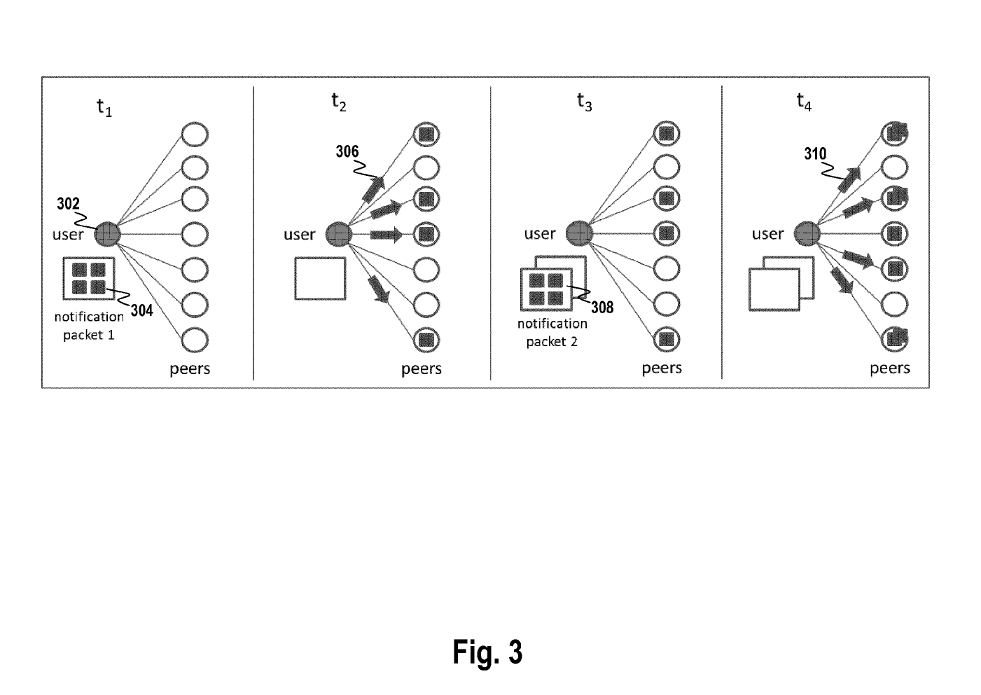

The procedure to randomize the delivery targets of automated notifications is illustrated in FIG. 3. As an application user 302 engaged in actions on the application during the course of normal use, for example when they rated a movie or friended a celebrity, packets of notifications 304 informing their friends of their use of the application were automatically generated in response to those actions and delivered to their randomly targeted peers 306. Each packet contained a fixed number of notifications, each of which was randomly targeted to a specific peer of the application user 302. This process was repeated for each action the user 302 took on the application. The number of notifications that a particular peer of an application user received at any given time was a function of a random Poisson process that depended only on the application user's sending rate (or the total number of notifications sent) and their network degree (the number of social network peers).

At time t₁, a packet of notifications 304 (notification packet 1) was generated. At time t₂, peer targets 306 were chosen randomly to be message recipients and were sent notifications from notification packet 1. At time t₃, a second packet of notifications 308 was generated (notification packet 2). At time t₄, another set of peer targets 310 were chosen randomly to be message recipients and were sent notifications from notification packet 2. Importantly, this second set of randomly chosen peer targets was selected independently of the set of peers randomly chosen to receive messages from the first notification packet. As a result, at any time t, a peer could have received zero, one, two, or more notifications from the application user. The quantity of influence-mediating notifications received by any particular peer j can be defined as Nⱼ(t). This quantity, the number of notifications received by peer j at time t, is the randomized treatment (rather than an observed proxy for the treatment). It reflects the peer's “risk group,” the extent to which they have been exposed to influence-mediating messages from their friend. Randomized treatment of peers occurred dynamically throughout the course of the experiment and was codified by the dynamic treatment variable Nⱼ(t). To handle dynamic changes in randomized treatment in the hazard model estimation, interval censoring was employed. When any peer received a notification at time t, they were censored out of their prior risk group, Nⱼ(t−ε) (where ε is some infinitesimal time), and censored into their new risk group, Nⱼ(t+ε)=Nⱼ(t−ε)+1. This censoring procedure correctly parameterizes the ignorance of what might have happened had the peer not received an additional notification at time t.

Throughout the experiment, dynamic profile data was collected on demographic and individual attributes of adopters and their peers, their social network relationships, time-stamped application and website activity, time-stamped delivery of automated notifications and time-stamped application adoption responses by peers of application users. Estimates of influence and susceptibility were then obtained by modeling time to peer adoption as a function of treatment, controlling for the number of notifications sent or received. Survival analysis techniques were employed measuring the time to peer adoption to estimate the effect of individual and dyadic attributes on influence exerted by application users on their peers as well as their peers' susceptibility to influence. This enabled an estimate for example whether women were more or less influential than men, whether older people were more or less susceptible to influence than younger people, whether married individuals were more or less likely to spontaneously adopt the product in the absence of peer influence than single individuals, and whether women had more influence over men or rather whether men had more influence over women.

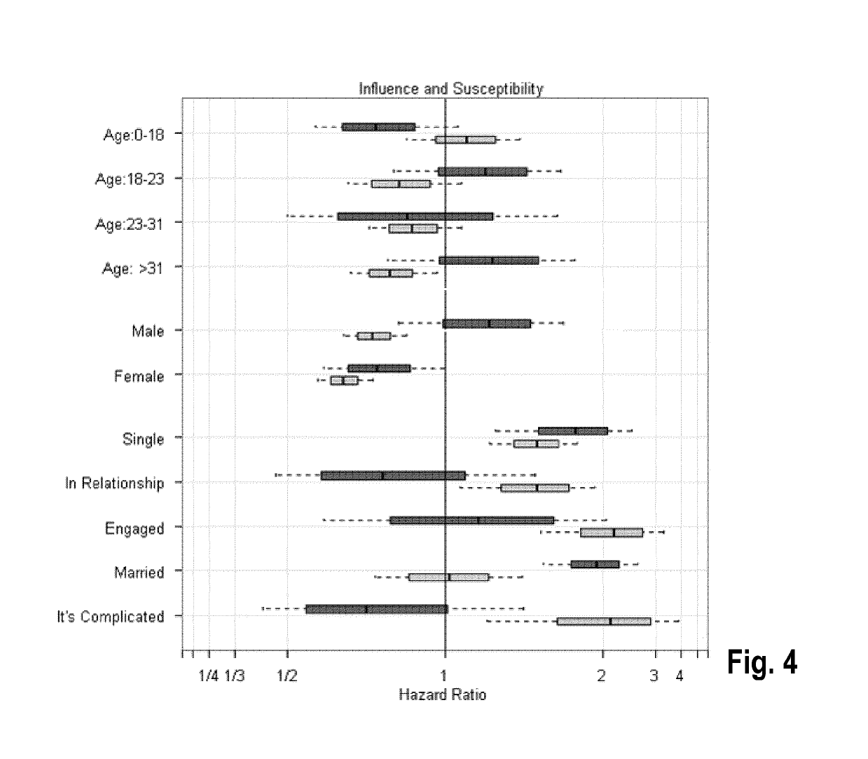

FIG. 4 illustrates the effects of age, gender, and relationship status on influence (dark grey) and susceptibility to influence (light grey) based upon experimental data in accordance with an illustrative implementation. The figure displays hazard ratios (HR) representing the percent increase (HR>1) or decrease (HR<1) in adoption hazards associated with a one unit increase in the independent variable holding all other variables constant. Age is binned by quartiles. Each age group or attribute is shown as a pair of estimates, one reflecting influence (dark grey) and the other susceptibility (light grey). Personal relationship status reflects the status of an individual's current romantic relationship and is specified on the social network site as: Single, In a Relationship, Engaged, Married, and It's Complicated. Estimates are shown relative to the baseline case for each attribute, which is the average for individuals who do not display that attribute in their online profile. For example, the estimate of single individuals' average influence (HR=1.71) is shown relative to the average influence of users who do not report their relationship status. Choice of the baseline does not affect the estimates themselves but only the category against which they are relatively represented in the figure. Results of the experiment show that influence increases with age while susceptibility to influence decreases with age. People over the age of 31 were the most influential and the least susceptible to influence (36% more influential than baseline users, p<0.05; 18% less susceptible than baseline users, p<0.05). Men were 49% more influential than women (p<0.05), but women were 12% less susceptible to influence than men (p=0.06) and 29% less susceptible than those who choose not to display their gender in their social networking profile (p<0.05).

Single and married individuals were the most influential. Single individuals were significantly more influential than those who are in a relationship (113% more influential, p<0.05) and those who reported their relationship status as ‘It's complicated’ (128% more influential, p<0.05). Married individuals were 140% more influential than those in a relationship (p<0.01) and 158% more influential than those who reported that ‘It's complicated’ (p<0.01). Susceptibility increases with increasing relationship commitment until the point of marriage. The engaged were 53% more susceptible to influence than single people (p<0.05), while married individuals were the least susceptible to influence (Married: N.S.). The engaged and those who reported that “It's complicated” were the most susceptible to influence. Those who reported that “It's complicated” were 111% more susceptible to influence than baseline users who did not report their relationship status p<0.05, and those who are engaged were 117% more susceptible than baseline users, p<0.001.

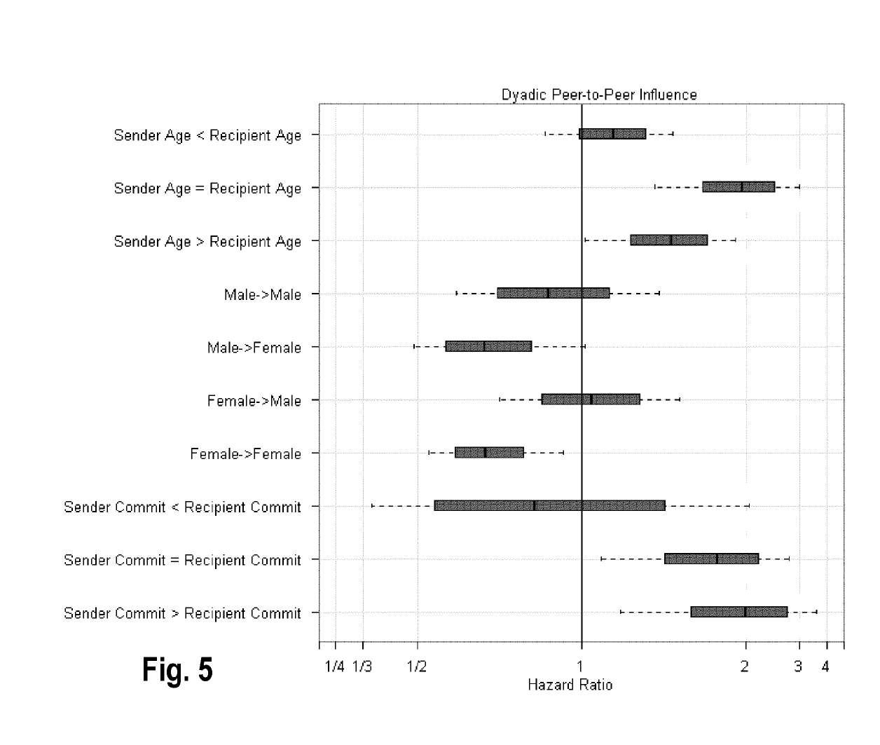

FIG. 5 illustrates the results of dyadic influence models involving age, gender and relationship status, including the relative age of senders and potential recipients, gender similarity, and the relative commitment level of the relationship status between sender and recipient pairs based upon experimental data in accordance with an illustrative implementation. FIG. 5 also displays standard errors (boxes) and 95% confidence intervals (whiskers). The figure displays hazard ratios (HR) representing the percent increase (HR>1) or decrease (HR<1) in adoption hazards associated with a one unit increase in the independent variable holding all other variables constant. The baseline case represents dyads in which the attribute being examined is unreported in the profile of one or both peers. In these models, the baseline represents dyads in which the attribute being examined is not reported for one or both peers. FIG. 5 illustrates that people exert the most influence on peers of the same age (97% more influence on peers of the same age than the baseline, p<0.01). They also seem to exert more influence on younger peers than on older peers though this difference is not significant. In non-dyadic susceptibility models (FIG. 4), women were found to be less susceptible to influence than both men and those who do not display their gender in their online profile. Dyadic models confirm this result (FIG. 5) and further reveal that women exert 67% less influence on women than on men (p<0.05). FIG. 5 also illustrates based upon the experimental data that men exert 26% less influence on women than baseline users exert on their peers (p<0.05). Together these results suggest that women were more influential over men than men were over women in the experiment's setting. Finally, based upon the experimental data individuals were more influential on peers who are in relationships of lesser or equal levels of commitment. For example, individuals in equally committed relationships and more committed relationships than their peers (e.g. those who are married compared to those who are engaged, in a relationship or single) are significantly more influential (Equally Committed: 70% more influential than baseline, p<0.01; More Committed: 101% more influential than baseline, p<0.05).

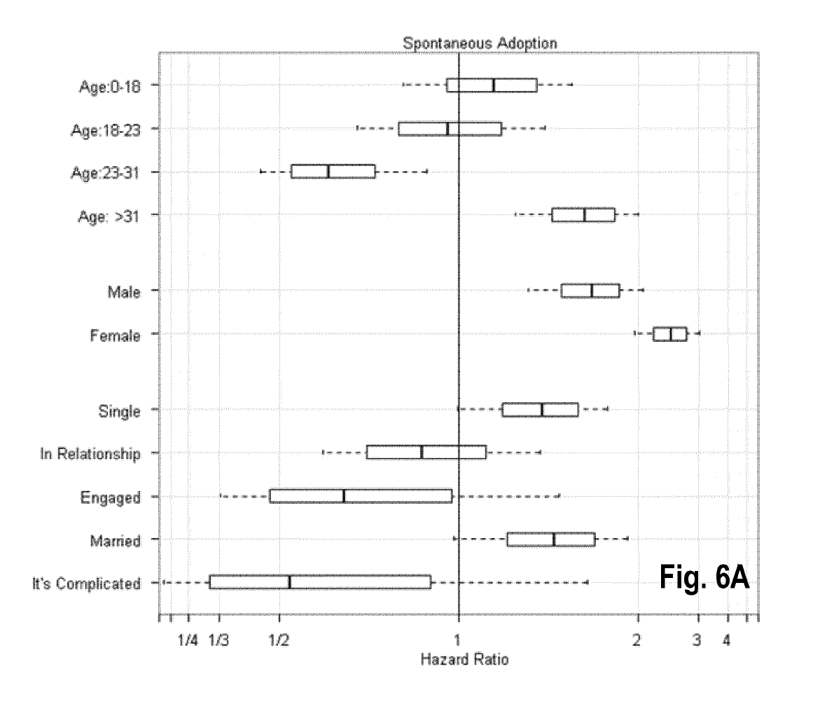

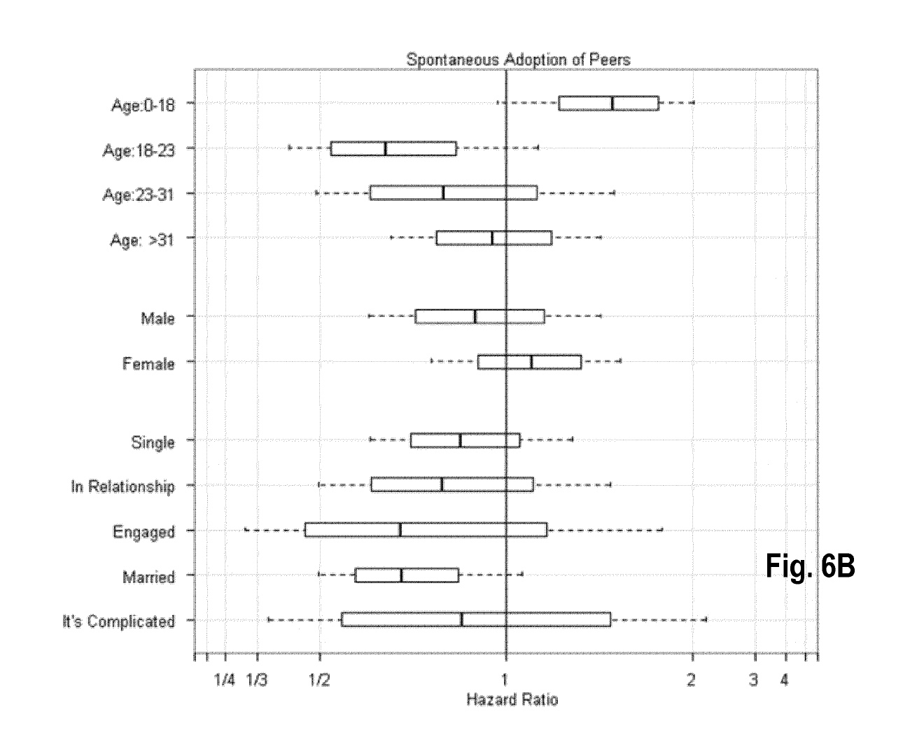

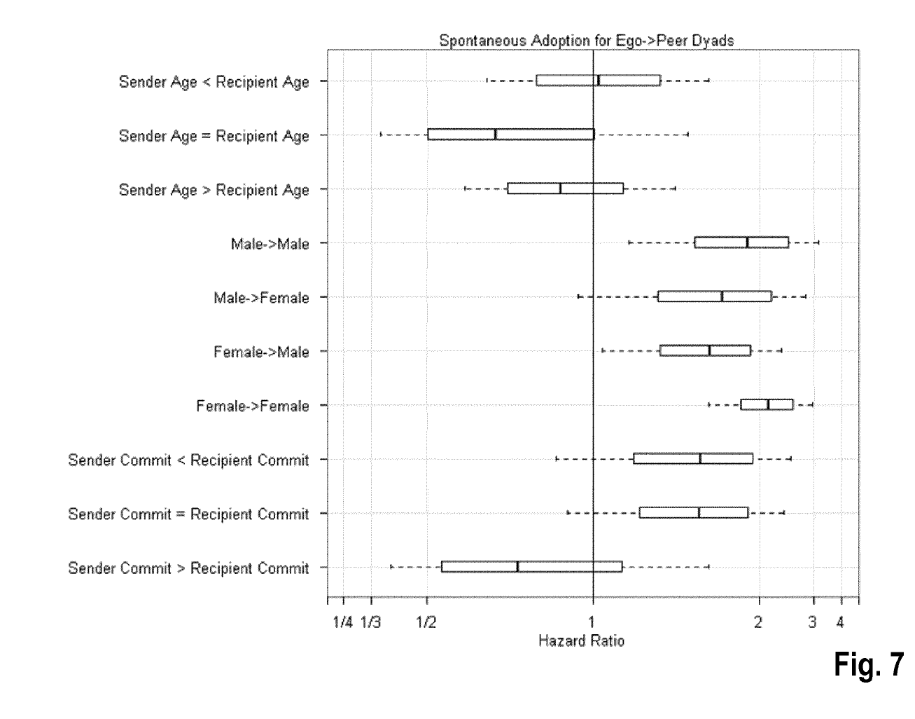

FIG. 6A displays the hazard ratio for individuals to adopt spontaneously as function of their attributes based upon experimental data in accordance with an illustrative implementation. FIG. 6B displays the hazard ratio for individuals to have local network peers adopt spontaneously as function of their attributes based upon experimental data in accordance with an illustrative implementation. FIGS. 6A and 6B display hazard ratios (HR) representing the percent increase (HR>1) or decrease (HR<1) in adoption hazards associated with a one unit increase in the independent variable holding all other variables constant. FIG. 7 displays hazard ratios associated with spontaneous peer adoption as a function of the dyadic relationship between message senders and recipients based upon experimental data in accordance with an illustrative implementation. The hazard ratios for spontaneous adoption estimates obtained from dyadic models indicate the hazard for an individual to have a particular peer (ego->peer dyad) spontaneously adopt in the absence of influence. Comparing spontaneous adoption hazards to influenced adoption hazards reveals the potential roles that different individuals play in the diffusion of a behavior, in the case of the experiment the adoption of the movie application. For example, both single and married individuals adopted spontaneously more often (Single: 31% more often, p<0.05; Married: 36% more often, p<0.06), were more influential than baseline users (Single: 71% more influential, p<0.01; Married: 94% more influential, p<0.001, from FIG. 4), and had peers who were no more likely to adopt spontaneously than the baseline (N.S.; N.S.). Similarly, individuals older than 31 adopted spontaneously 70% more often than baseline users (p<0.01), were 36% more influential than baseline users (p<0.05, from FIG. 4), and had peers who were no more likely to adopt spontaneously than the baseline (N.S.). This suggests that influence exerted by single and married individuals positively contributes to this product's diffusion in the population without any need to target them. On the other hand, women are poor candidates for targeted advertising designed to broadly diffuse the product because they are already likely to adopt spontaneously and are 22% less influential on their peers than baseline (p<0.05). Those who claim their relationship status is complicated are easily influenced by their peers to adopt (35% more susceptible than baseline, p<0.05), but are not influential enough to spread the product further (N.S.). These results have implications for policies designed to promote or inhibit diffusion and illustrate the general utility of the method for informing intervention strategies, targeted advertising and policy making more generally. In contrast to the data associated with single and married individuals, individuals aged 0-18 tended to spontaneously adopt 30% more often than baseline (p=0.07) and had peers that spontaneously adopted 42% more often than baseline (p<0.05), but on average exerted 20% less influence on their peers than baseline users (N.S.), suggesting that influence exerted by these individuals does not, on average, contribute to the product's diffusion.

In another implementation, an advertisement or message can be targeted to identified influential individuals. The targeted messages can be used in informing intervention strategies, targeting and policy making.

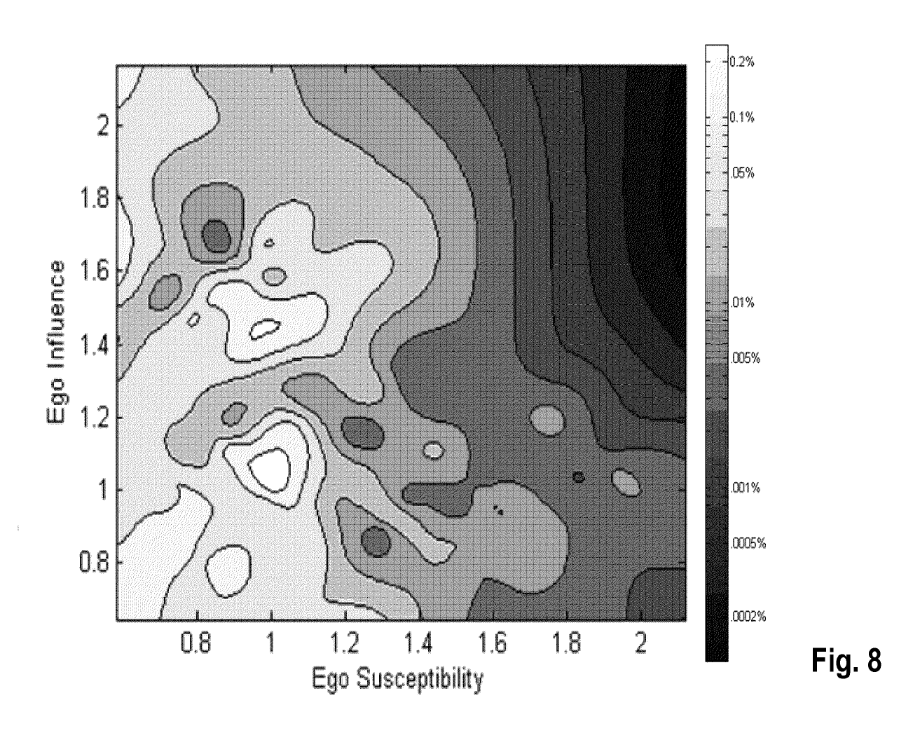

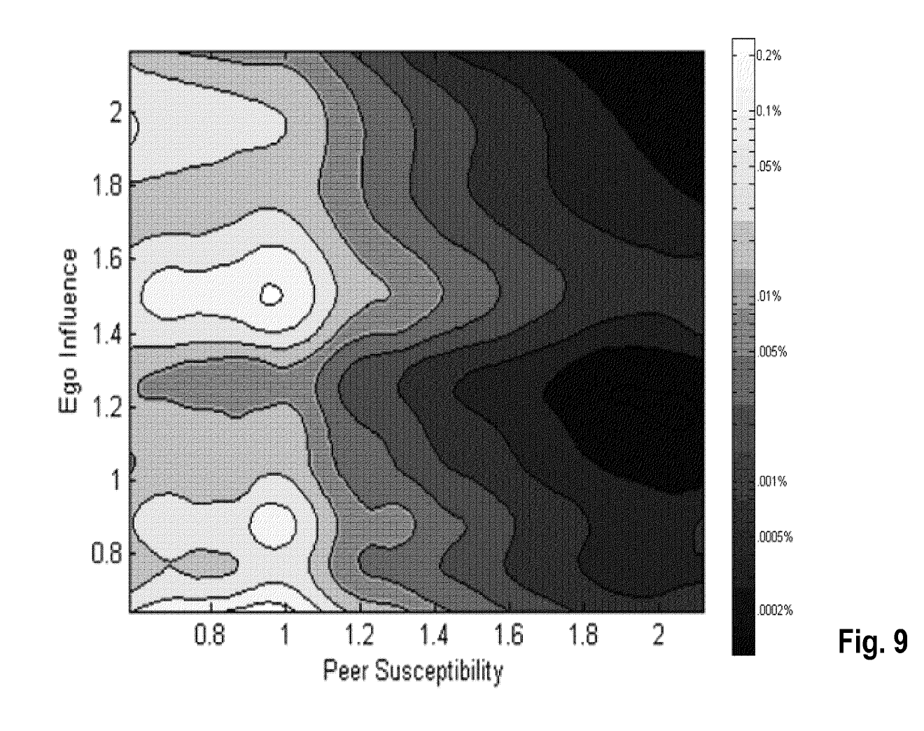

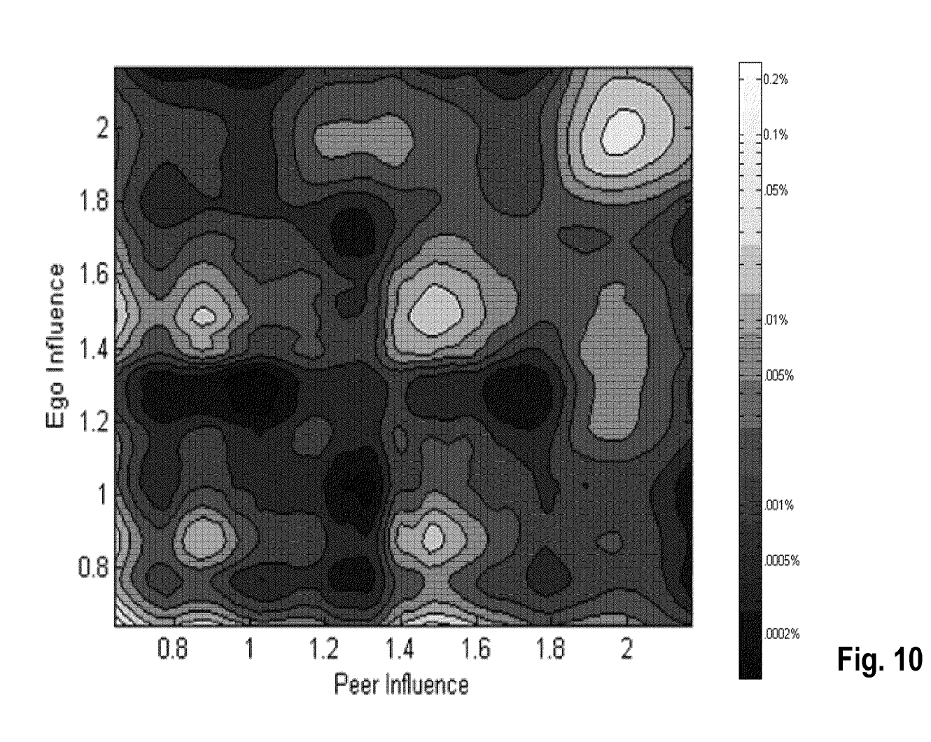

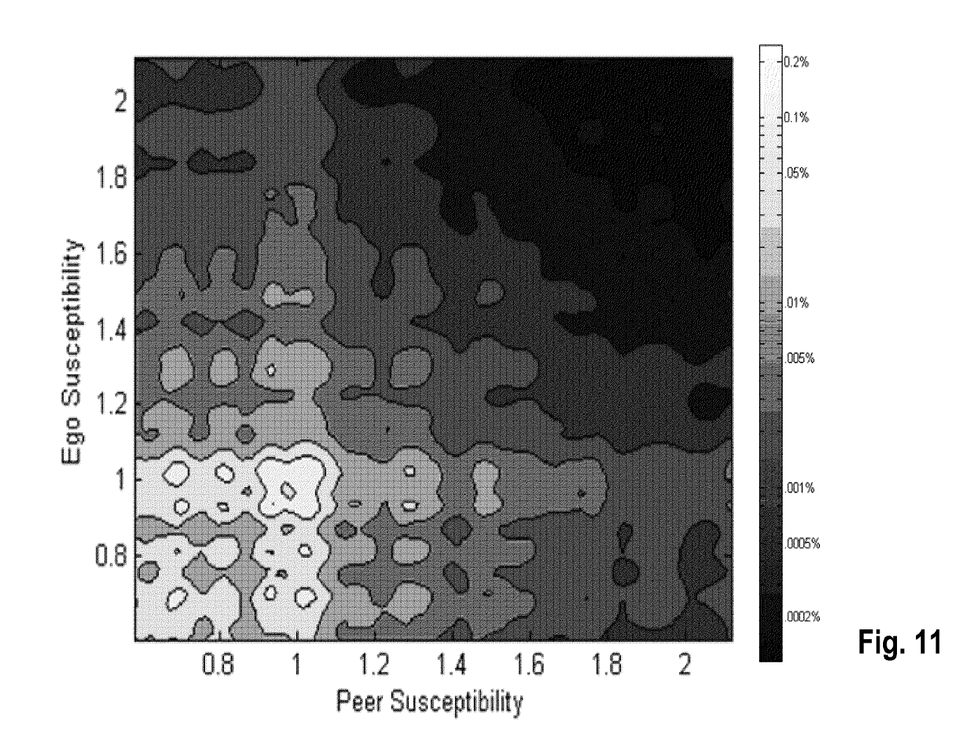

FIG. 8 illustrates the joint distributions of ego influence and susceptibility based upon the experimental data in accordance with an illustrative implementation. FIG. 9 illustrates ego influence and peer susceptibility based upon the experimental data in accordance with an illustrative implementation. FIG. 10 illustrates ego influence and peer influence based upon the experimental data in accordance with an illustrative implementation. FIG. 11 illustrates ego susceptibility and peer susceptibility based upon the experimental data in accordance with an illustrative implementation. Ego refers to a person that sent a communication. Individual influence and susceptibility scores were calculated as the product of the estimated hazard ratios of individuals' attributes. For example, a thirty five year old single female has an influence score equal to

exp[β_{Infl>31}+β_{Infl,single}+β_{Infl,female}].

Several interesting insights about the joint distribution of influence and susceptibility in the population can be seen in FIGS. 8-11. First, influence and susceptibility traded off. Highly influential individuals tended not to be susceptible, highly susceptible individuals tended not to be influential and almost no one was both highly influential and highly susceptible to influence (see FIG. 8). In one implementation, therefore, an advertisement and/or message is targeted to identified influential individuals. The targeted influential individuals can influence peers and positively influence the natural influence process.

Second, both influential individuals and non-influential individuals had approximately the same distribution of susceptibility to influence among their peers, demonstrating that being influential was not simply a product of having susceptible peers (See FIG. 9). This can imply that the influentials hypothesis and the susceptibles hypothesis are orthogonal claims. Third, there was greater heterogeneity in influence than in susceptibility. Both highly influential and non-influential individuals were well represented in the population, whereas highly susceptible individuals were rarer (See FIG. 8). In one implementation of a peer-oriented targeting policy, messages can be targeted toward individuals that have common characteristics with current adopters, which encourages influence, rather than on attributes of peers of influencers. Thus, in this implementation, influential individuals are targeted instead of susceptible individuals or those with susceptible peers. Targeting influential users instead of susceptible individuals or those with susceptible peers can reduce the number of messages that are sent. As not all peer adopters are equal (some are more influential than others), more refined policies can prioritize individuals that are both highly influential and have highly influential peers. For example, messages can be targeted to individuals that are both highly influential and have highly influential peers.

Fourth, influentials clustered in the network (FIG. 10) which revealed the existence of a pocket of potential ‘super-spreaders,’ influential individuals connected to other influential peers who are approximately twice as influential as baseline users. In one implementation, the super-spreaders are identified and messages are targeted to the super-spreaders. Finally, in contrast, no clusters of highly susceptible users were found (FIG. 11). Instead, there was a tendency for less susceptible users to cluster together and this seems to be the case for varying degrees of lesser susceptibility (as compared to the baseline).

To assure the integrity of the randomization procedure, the conditional logistic regression models estimating the number of notifications received by peers as a function of peer age, gender, and relationship status as well as the number of common friends between the peer and her application user friend (a measure of the embeddedness of the relationship and a proxy for the strength of the tie) were evaluated. Conditional logistic regression models are appropriate as they evaluate the dependence of the number of notifications received on peer attributes, conditional on the stratified grouping of peers with their common application user friend whose own activity on the application determines the rate at which peers receive notifications and the total number of notifications sent to all peers. The results, shown in Table A5 reveal no statistically significant dependence of the number of notifications received on any of the peer attributes considered, confirming the integrity of the randomization procedure.

TABLE A5
Integrity of Randomization via Conditional Logistic Regression Models

| | β | exp(β) | se(β) | z | P-value |
|---|---|---|---|---|---|
| Number common | 7.41E−05 | 1.000 | 0.000 | 0.228 | 0.820 |
| friends | | | | | |
| Age 0-18 | −5.08E−03 | 0.995 | 0.027 | −0.190 | 0.850 |
| Age 18-23 | −1.54E−02 | 0.985 | 0.027 | −0.578 | 0.560 |
| Age 23-31 | 1.75E−03 | 1.002 | 0.027 | 0.065 | 0.950 |
| Age 31+ | 6.12E−03 | 1.006 | 0.024 | 0.260 | 0.790 |
| Male | 2.12E−02 | 1.021 | 0.021 | 1.002 | 0.320 |
| Female | 1.28E−02 | 1.013 | 0.019 | 0.660 | 0.510 |
| Single | −1.15E−03 | 0.999 | 0.029 | −0.040 | 0.970 |
| In Relationship | 4.01E−02 | 1.041 | 0.034 | 1.187 | 0.240 |
| Engaged | −7.17E−02 | 0.931 | 0.063 | −1.134 | 0.260 |
| Married | 2.34E−02 | 1.024 | 0.036 | 0.650 | 0.520 |
| It's Complicated | 9.93E−02 | 1.104 | 0.090 | 1.110 | 0.270 |

Notes:
This table reports parameter estimates, standard errors, hazard ratios, z-scores, and p-values for the conditional logistic regression of a peer receiving one or more notifications conditional on her particular application user friend. The dependent variables indicate the peer's attributes. The number of common friends is the number of friends a peer shares in common with her application user friend.

Parameter estimates, confidence intervals and p-values for the forest plots described in FIGS. 4-6B are displayed in Tables A6 and A7. For example, the parameter estimates indicate that all else equal, the marginal effect of receiving an additional notification increases the hazard rate of adoption by 474% on average. In the Influence and Susceptibility Cox Proportional Hazards Model, the baseline represents individuals who do not report age, gender, and relationship status as part of their profile. In the Dyadic Cox Proportional Hazards Model, the baseline represents dyads in which the attributes are undefined or not reported for one or both members of the dyad (the individual and their peer).

TABLE A6
Estimates from Influence and Susceptibility Cox Proportional Hazards Model

| | | | | | | CI Lower |
|---|---|---|---|---|---|---|
| | β | exp(β) | se(β) | z | Pr(>\|z\|) | .95 |
| | Treatment (β_{N} ) | | | | | |
| # Notifications | 1.747 | 5.736 | 0.045 | 38.543 | <2e-16 | 5.249 |
| | Spontaneous Adoption of i (β_{Spont}ⁱ) | | | | | |
| Age (0-18) | 0.338 | 1.403 | 0.165 | 2.046 | 0.041 | 1.014 |
| Age (18-23) | −0.389 | 0.678 | 0.234 | −1.665 | 0.096 | 0.429 |
| Age (23-31) | −0.184 | 0.832 | 0.225 | −0.816 | 0.415 | 0.535 |
| Age (>31) | −0.038 | 0.963 | 0.160 | −0.237 | 0.813 | 0.704 |
| Male | −0.085 | 0.919 | 0.172 | −0.495 | 0.620 | 0.656 |
| Female | 0.072 | 1.075 | 0.132 | 0.545 | 0.586 | 0.830 |
| Single | −0.129 | 0.879 | 0.151 | −0.852 | 0.394 | 0.654 |
| Relationship | −0.185 | 0.831 | 0.210 | −0.879 | 0.379 | 0.550 |
| Engaged | −0.330 | 0.719 | 0.414 | −0.797 | 0.426 | 0.319 |
| Married | −0.326 | 0.722 | 0.186 | −1.756 | 0.079 | 0.502 |
| Its Complicated | −0.125 | 0.883 | 0.419 | −0.298 | 0.766 | 0.388 |
| | CI | | | | Robust | |
| | Upper | Robust | Robust | Robust | CI Lower | Robust CI |
| | .95 | se(β) | z | Pr(>\|z\|) | .95 | Upper .95 |
| | Treatment (β_{N}) | | | | | |
| # Notifications | 6.269 | 0.084 | 20.85 | <2e-16 | 4.868 | 6.760 |
| | Spontaneous Adoption of i (β_{Spont}ⁱ) | | | | | |
| Age (0-18) | 1.940 | 0.184 | 1.838 | 0.066 | 0.978 | 2.012 |
| Age (18-23) | 1.072 | 0.244 | −1.597 | 0.110 | 0.421 | 1.092 |
| Age (23-31) | 1.294 | 0.268 | −0.685 | 0.493 | 0.492 | 1.408 |
| Age (>31) | 1.316 | 0.169 | −0.224 | 0.823 | 0.691 | 1.341 |
| Male | 1.286 | 0.191 | −0.444 | 0.657 | 0.631 | 1.337 |
| Female | 1.392 | 0.150 | 0.478 | 0.633 | 0.800 | 1.443 |
| Single | 1.182 | 0.165 | −0.777 | 0.437 | 0.636 | 1.216 |
| Relationship | 1.256 | 0.262 | −0.706 | 0.480 | 0.497 | 1.389 |
| Engaged | 1.619 | 0.444 | −0.743 | 0.457 | 0.301 | 1.716 |
| Married | 1.039 | 0.190 | −1.720 | 0.085 | 0.498 | 1.047 |
| Its Complicated | 2.008 | 0.453 | −0.275 | 0.783 | 0.363 | 2.146 |
| | | | | | | CI Lower |
| | β | exp(β) | se(β) | z | Pr(>\|z\|) | .95 |
| | Spontaneous Adoption of j (β_{Spont}^{j}) | | | | | |
| Age (0-18) | 0.105 | 1.111 | 0.151 | 0.695 | 0.487 | 0.826 |
| Age (18-23) | −0.028 | 0.972 | 0.160 | −0.177 | 0.860 | 0.710 |
| Age (23-31) | −0.447 | 0.640 | 0.190 | −2.353 | 0.019 | 0.441 |
| Age (>31) | 0.433 | 1.542 | 0.136 | 3.176 | 0.001 | 1.181 |
| Male | 0.466 | 1.593 | 0.132 | 3.518 | 0.000 | 1.229 |
| Female | 0.894 | 2.444 | 0.112 | 7.957 | 0.000 | 1.961 |
| Single | 0.266 | 1.305 | 0.133 | 1.994 | 0.046 | 1.005 |
| Relationship | −0.107 | 0.899 | 0.189 | −0.567 | 0.571 | 0.621 |
| Engaged | −0.381 | 0.683 | 0.411 | −0.926 | 0.354 | 0.305 |
| Married | 0.310 | 1.363 | 0.162 | 1.911 | 0.056 | 0.992 |
| Its Complicated | −0.633 | 0.531 | 0.641 | −0.987 | 0.324 | 0.151 |
| | CI | | | | Robust | |
| | Upper | Robust | Robust | Robust | CI Lower | Robust CI |
| | .95 | se(β) | z | Pr(>\|z\|) | .95 | Upper .95 |
| | Spontaneous Adoption of j (β_{Spont}^{j}) | | | | | |
| Age (0-18) | 1.493 | 0.139 | 0.753 | 0.452 | 0.845 | 1.459 |
| Age (18-23) | 1.331 | 0.155 | −0.183 | 0.855 | 0.718 | 1.317 |
| Age (23-31) | 0.928 | 0.181 | −2.468 | 0.014 | 0.448 | 0.912 |
| Age (>31) | 2.015 | 0.133 | 3.264 | 0.001 | 1.189 | 2.001 |
| Male | 2.064 | 0.128 | 3.640 | 0.000 | 1.240 | 2.047 |
| Female | 3.046 | 0.111 | 8.020 | 0.000 | 1.965 | 3.041 |
| Single | 1.695 | 0.137 | 1.936 | 0.053 | 0.997 | 1.708 |
| Relationship | 1.301 | 0.187 | −0.573 | 0.567 | 0.623 | 1.296 |
| Engaged | 1.529 | 0.362 | −1.053 | 0.292 | 0.336 | 1.389 |
| Married | 1.873 | 0.165 | 1.881 | 0.060 | 0.987 | 1.883 |
| Its Complicated | 1.866 | 0.550 | −1.151 | 0.250 | 0.181 | 1.560 |
| | | | | | | CI Lower |
| | β | exp(β) | se(β) | z | Pr(>\|z\|) | .95 |
| | Influence (β_{Infl}) | | | | | |
| Age (0-18) | −0.245 | 0.782 | 0.132 | −1.853 | 0.064 | 0.604 |
| Age (18-23) | 0.139 | 1.149 | 0.154 | 0.904 | 0.366 | 0.850 |
| Age (23-31) | −0.125 | 0.882 | 0.238 | −0.528 | 0.598 | 0.554 |
| Age (>31) | 0.167 | 1.182 | 0.154 | 1.081 | 0.280 | 0.873 |
| Male | 0.154 | 1.166 | 0.140 | 1.101 | 0.271 | 0.887 |
| Female | −0.243 | 0.784 | 0.102 | −2.391 | 0.017 | 0.642 |
| Single | 0.538 | 1.712 | 0.139 | 3.863 | 0.000 | 1.303 |
| Relationship | −0.217 | 0.805 | 0.292 | −0.743 | 0.457 | 0.454 |
| Engaged | 0.115 | 1.121 | 0.345 | 0.332 | 0.740 | 0.570 |
| Married | 0.660 | 1.935 | 0.163 | 4.041 | 0.000 | 1.405 |
| Its Complicated | −0.286 | 0.751 | 0.411 | −0.695 | 0.487 | 0.336 |
| | CI | | | | Robust | |
| | Upper | Robust | Robust | Robust | CI Lower | Robust CI |
| | .95 | se(β) | z | Pr(>\|z\|) | .95 | Upper .95 |
| | Influence (β_{Infl}) | | | | | |
| Age (0-18) | 1.014 | 0.146 | −1.677 | 0.094 | 0.587 | 1.042 |
| Age (18-23) | 1.553 | 0.161 | 0.861 | 0.389 | 0.837 | 1.577 |
| Age (23-31) | 1.405 | 0.290 | −0.433 | 0.665 | 0.500 | 1.557 |
| Age (>31) | 1.599 | 0.186 | 0.897 | 0.370 | 0.821 | 1.701 |
| Male | 1.534 | 0.161 | 0.955 | 0.340 | 0.850 | 1.600 |
| Female | 0.957 | 0.125 | −1.942 | 0.052 | 0.613 | 1.002 |
| Single | 2.249 | 0.185 | 2.915 | 0.004 | 1.193 | 2.458 |
| Relationship | 1.426 | 0.282 | −0.770 | 0.441 | 0.464 | 1.398 |
| Engaged | 2.207 | 0.306 | 0.375 | 0.708 | 0.616 | 2.043 |
| Married | 2.666 | 0.146 | 4.515 | 0.000 | 1.453 | 2.578 |
| Its Complicated | 1.682 | 0.293 | −0.976 | 0.329 | 0.424 | 1.334 |
| | | | | | | CI Lower |
| | β | exp(β) | se(β) | z | Pr(>\|z\|) | .95 |
| | Susceptibility (β_{Susc}) | | | | | |
| Age (0-18) | 0.072 | 1.074 | 0.109 | 0.660 | 0.510 | 0.868 |
| Age (18-23) | −0.157 | 0.854 | 0.120 | −1.306 | 0.192 | 0.675 |
| Age (23-31) | −0.110 | 0.895 | 0.130 | −0.849 | 0.396 | 0.694 |
| Age (>31) | −0.192 | 0.825 | 0.112 | −1.710 | 0.087 | 0.662 |
| Male | −0.259 | 0.772 | 0.091 | −2.843 | 0.004 | 0.646 |
| Female | −0.388 | 0.678 | 0.071 | −5.463 | 0.000 | 0.590 |
| Single | 0.347 | 1.415 | 0.113 | 3.071 | 0.002 | 1.134 |
| Relationship | 0.349 | 1.417 | 0.171 | 2.036 | 0.042 | 1.013 |
| Engaged | 0.774 | 2.168 | 0.262 | 2.952 | 0.003 | 1.297 |
| Married | 0.014 | 1.014 | 0.147 | 0.094 | 0.925 | 0.759 |
| Its Complicated | 0.748 | 2.112 | 0.405 | 1.846 | 0.065 | 0.955 |
| | CI | | | | Robust | |
| | Upper | Robust | Robust | Robust | CI Lower | Robust CI |
| | .95 | se(β) | z | Pr(>\|z\|) | .95 | Upper .95 |
| | Susceptibility (β_{Susc}) | | | | | |
| Age (0-18) | 1.330 | 0.102 | 0.704 | 0.482 | 0.880 | 1.312 |
| Age (18-23) | 1.082 | 0.107 | −1.468 | 0.142 | 0.693 | 1.054 |
| Age (23-31) | 1.156 | 0.084 | −1.322 | 0.186 | 0.760 | 1.055 |
| Age (>31) | 1.029 | 0.085 | −2.261 | 0.024 | 0.698 | 0.975 |
| Male | 0.923 | 0.066 | −3.918 | 0.000 | 0.678 | 0.879 |
| Female | 0.780 | 0.064 | −6.024 | 0.000 | 0.598 | 0.770 |
| Single | 1.765 | 0.099 | 3.494 | 0.000 | 1.165 | 1.719 |
| Relationship | 1.983 | 0.152 | 2.293 | 0.022 | 1.052 | 1.910 |
| Engaged | 3.623 | 0.209 | 3.700 | 0.000 | 1.439 | 3.265 |
| Married | 1.354 | 0.135 | 0.102 | 0.919 | 0.778 | 1.322 |
| Its Complicated | 4.672 | 0.308 | 2.432 | 0.015 | 1.156 | 3.859 |

Notes:
This table reports parameter estimates, hazard ratios, z-scores, confidence intervals and P-values for the Influence and Susceptibility Cox proportional hazards model that estimate the impact of a user's age, gender or relationship status on his hazard to influence peers to adopt and on the hazard that his peers will spontaneously adopt. The table summarizes the model of influenced and spontaneous adoption with age, gender and relationship status as independent variables, while controlling for the remaining attributes.

TABLE A7
Estimates from Dyadic Cox Proportional Hazards Model

| | | | | | | CI Lower |
|---|---|---|---|---|---|---|
| | β | exp(β) | se(β) | z | Pr(>\|z\|) | .95 |
| | Treatment (β_{N}) | | | | | |
| # Notifications | 1.596 | 4.934 | 0.029 | 55.009 | <2e-16 | 0.062 |
| | Spontaneous Adoption (β_{Spont}ⁱ) | | | | | |
| S Age < R Age | −0.102 | 0.903 | 0.201 | −0.506 | 0.613 | 0.196 |
| S Age = R Age | −0.343 | 0.710 | 0.377 | −0.909 | 0.363 | 0.346 |
| S Age > R Age | 0.020 | 1.020 | 0.213 | 0.092 | 0.927 | 0.208 |
| Male → Male | 0.627 | 1.872 | 0.271 | 2.314 | 0.021 | 0.261 |
| Male → Female | 0.492 | 1.636 | 0.275 | 1.791 | 0.073 | 0.274 |
| Female → Male | 0.434 | 1.543 | 0.213 | 2.038 | 0.042 | 0.207 |
| Female → Female | 0.757 | 2.131 | 0.164 | 4.606 | 0.000 | 0.166 |
| S Com < R Com | −0.257 | 0.773 | 0.348 | −0.738 | 0.461 | 0.349 |
| S Com = R Com | 0.389 | 1.475 | 0.237 | 1.643 | 0.100 | 0.239 |
| S Com > R Com | 0.394 | 1.483 | 0.270 | 1.460 | 0.144 | 0.262 |
| | CI Upper | Robust | Robust | Robust | Robust CI | Robust CI |
| | .95 | se(β) | z | Pr(>\|z\|) | Lower .95 | Upper .95 |
| | Treatment (β_{N}) | | | | | |
| # Notifications | 25.945 | <2e-16 | 4.374 | 5.567 | 1.596 | 4.934 |
| | Spontaneous Adoption (β_{Spont}ⁱ) | | | | | |
| S Age < R Age | −0.518 | 0.604 | 0.615 | 1.327 | −0.102 | 0.903 |
| S Age = R Age | −0.990 | 0.322 | 0.360 | 1.399 | −0.343 | 0.710 |
| S Age > R Age | 0.094 | 0.925 | 0.679 | 1.532 | 0.020 | 1.020 |
| Male → Male | 2.399 | 0.016 | 1.122 | 3.125 | 0.627 | 1.872 |
| Male → Female | 1.798 | 0.072 | 0.957 | 2.797 | 0.492 | 1.636 |
| Female → Male | 2.100 | 0.036 | 1.029 | 2.313 | 0.434 | 1.543 |
| Female → Female | 4.554 | 0.000 | 1.539 | 2.952 | 0.757 | 2.131 |
| S Com < R Com | −0.736 | 0.462 | 0.390 | 1.534 | −0.257 | 0.773 |
| S Com = R Com | 1.624 | 0.104 | 0.923 | 2.358 | 0.389 | 1.475 |
| S Com > R Com | 1.504 | 0.132 | 0.888 | 2.479 | 0.394 | 1.483 |
| | β | exp(β) | se(β) | z | Pr(>\|z\|) | CI Lower .95 |
| | Influence (β_{Infl}) | | | | | |
| S Age < R Age | 0.323 | 1.381 | 0.161 | 2.012 | 0.044 | 0.160 |
| S Age = R Age | 0.676 | 1.965 | 0.324 | 2.082 | 0.037 | 0.215 |
| S Age > R Age | 0.105 | 1.111 | 0.167 | 0.629 | 0.529 | 0.113 |
| Male → Male | −0.106 | 0.899 | 0.188 | −0.563 | 0.573 | 0.193 |
| Male → Female | −0.351 | 0.704 | 0.154 | −2.284 | 0.022 | 0.185 |
| Female → Male | 0.033 | 1.034 | 0.184 | 0.182 | 0.855 | 0.164 |
| Female → Female | −0.343 | 0.710 | 0.110 | −3.119 | 0.002 | 0.146 |
| S Com < R Com | 0.697 | 2.009 | 0.349 | 1.997 | 0.046 | 0.290 |
| S Com = R Com | 0.533 | 1.704 | 0.253 | 2.111 | 0.035 | 0.241 |
| S Com > R Corn | −0.153 | 0.858 | 0.572 | −0.268 | 0.789 | 0.445 |
| | | | | | Robust CI | Robust CI |
| | CI Upper | Robust | | Robust | Lower | Upper |
| | .95 | se(β) | Robust z | Pr(>\|z\|) | .95 | .95 |
| | Influence (β_{Infl}) | | | | | |
| S Age < R Age | 2.017 | 0.044 | 1.009 | 1.890 | 0.323 | 1.381 |
| S Age = R Age | 3.144 | 0.002 | 1.290 | 2.995 | 0.676 | 1.965 |
| S Age > R Age | 0.929 | 0.353 | 0.890 | 1.386 | 0.105 | 1.111 |
| Male → Male | −0.550 | 0.582 | 0.616 | 1.313 | −0.106 | 0.899 |
| Male → Female | −1.898 | 0.058 | 0.490 | 1.012 | −0.351 | 0.704 |
| Female → Male | 0.204 | 0.838 | 0.750 | 1.426 | 0.033 | 1.034 |
| Female → Female | −2.343 | 0.019 | 0.533 | 0.945 | −0.343 | 0.710 |
| S Com < R Com | 2.401 | 0.016 | 1.137 | 3.549 | 0.697 | 2.009 |
| S Com = R Com | 2.211 | 0.027 | 1.062 | 2.734 | 0.533 | 1.704 |
| S Com > R Com | −0.343 | 0.731 | 0.358 | 2.055 | −0.153 | 0.858 |

Notes:
This table reports parameter estimates, hazard ratios, confidence intervals and P-values for the Cox proportional hazard model that estimate the impact of a dyadic attributes of a sender/(potential)-recipient pair on the hazard that the potential recipient in the dyad will adopt via influence and on the hazard that he will spontaneously adopt. Dyadic attributes considered include indicators of where the Sender is older, younger or the same age as the recipient; the possible gender combinations of Sender and Recipient; and whether the Sender is in a relationship that is less, equally or more committed than the relationship the Recipient is in. The table summarizes the model of influenced and spontaneous adoption pertaining to age-related, gender-related and relationship status-related dyadic measures, while controlling for the remaining dyadic attributes.

Several tests were employed to assess specification and goodness-of-fit of the influence and susceptibility proportional hazards model and the dyadic peer-to-peer influence proportional hazards model. Cox proportional hazard models employ iterative fitting procedures to obtain estimates that maximize pseudo log-likelihood. The pseudo log-likelihood of the intercept-only model as well as the pseudo log-likelihood of the model with all included dependent covariates, the Likelihood Ratio, Wald and Score Tests, as well as concordance probability assessments of these models are all reported in Table A8. The Likelihood Ratio (LRT) Test evaluates the likelihood of the data under the fitted model relative to the null (intercept only) model and the associated test statistic converges to a chi-squared distribution. The LRT test statistic for the influence and susceptibility model is 1470 over 45 degrees of freedom (p<1e-12) indicating a significantly better fit for the full model. The Wald Test (WT) assesses the likelihood of the data under the fitted model in a manner similar to the LRT, but employs a Taylor series expansion around β=β_{final} and adjusts for tied failure times. The Score Test (ST) assess the likelihood of the data under the fitted model in a manner similar to the WT, but employs a Taylor series expansion around β=0, uses estimated clustered standard errors and adjusts for tied times. The LRT, WT, and ST test statistics for the influence and susceptibility model are LRT=1470, WT=2637, and ST=357.2 over 45 degrees of freedom (p<1e-12) and for the dyadic peer-to-peer influence models are LRT=1274, WT=1271, and ST=272 over 23 degrees of freedom (p<1e-12). These tests uniformly confirm a significantly better fit for the full model specifications over the null model specifications.

TABLE A8
Goodness of Fit Tests Influence and Susceptibility and Dyadic
Peer-to-Peer Cox Proportional Hazards Models

| | | | | | | | Con- |
|---|---|---|---|---|---|---|---|
| | | | | Likeli- | | | cor- |
| | Log | Log | D | hood | | | dance |
| | Likelihood | Likeli- | O | Ratio | Wald | Score | Proba- |
| | (Intercept) | hood | F | Test | Test | Test | bility |
| Influence and | −13516.15 | −12780.92 | 45 | 1470 | 2637 | 357.2 | 78% |
| Susceptibility | | | | | | | |
| Dyadic Peer- | −13516.15 | −12879.06 | 23 | 1274 | 1271 | 272 | 73% |
| to-Peer | | | | | | | |

To assess the extent to which survival times of peers were in accordance with their estimated hazards to fail (adopt), concordance probability tests were employed which compare the relative order of survival for all pairs of peers in the data to the expected relative order of survival under the fitted model. The concordance probability (the proportion of observed relative peer survivals that are in accordance with model predictions) associated with the influence and susceptibility model is 78%, indicating relative survival of peer pairs as compared to predicted relative survival occurs with reasonable probability. The concordance probability for the dyadic peer-to-peer is 73%, indicating that predicted relative survival order occurs with reasonable probability.

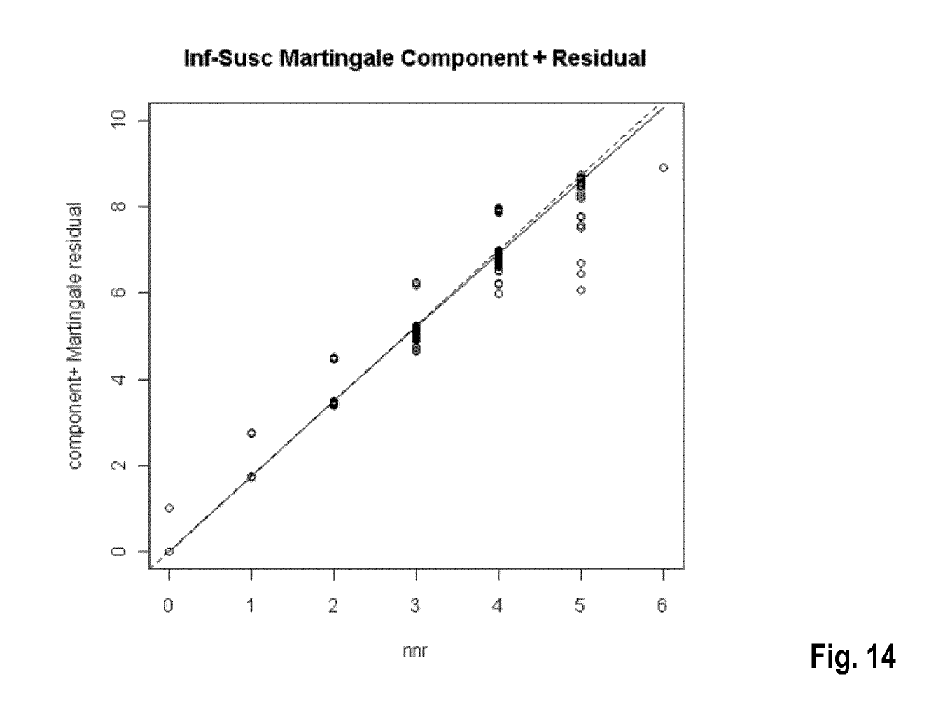

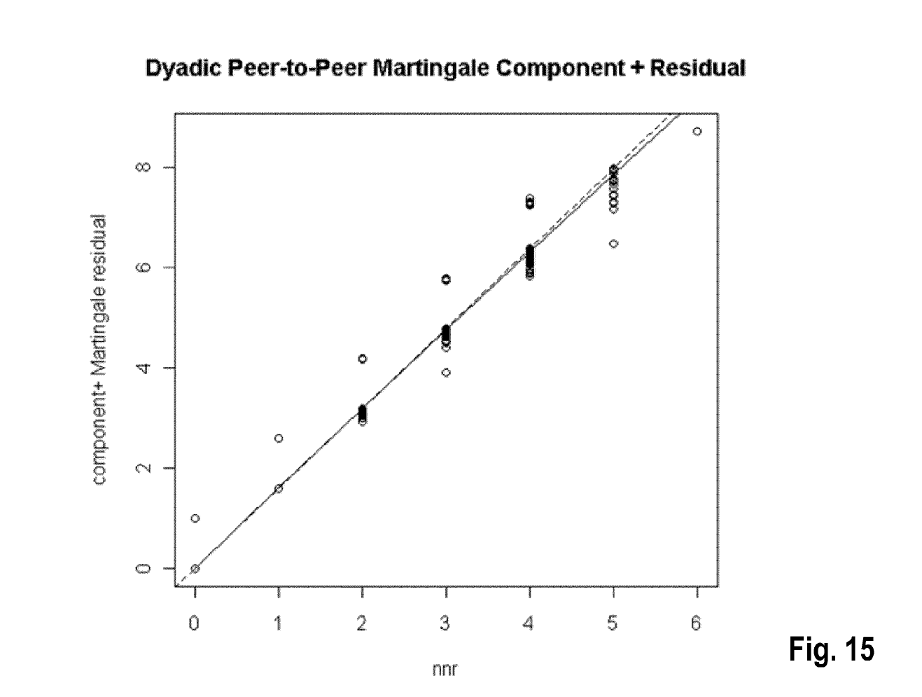

In addition to formal statistical tests of specification and goodness-of-fit, graphical analysis of residuals for survival models were performed. Plots of component+Martingale residuals vs. linear covariates assess the extent to which assumptions of covariate linearity hold. In the discussed models, covariates are largely dichotomous, with the exception of number of notifications received (nnr). Plots of component+Martingale residuals vs. number of notifications received are displayed in FIGS. 14 and 15. These residuals indicate only a slight non-linearity as evidenced by the departure of the (solid) lowess curve from the (dotted line) linear fit. This departure occurs for number of notifications received driven by larger values (nnr>3). Since the bulk of peers (99%) received fewer notifications (nnr<3), it is unlikely that the discussed model estimates are significantly impacted by this slight non-linearity displayed. Furthermore, because of the focus on the modulating impact of dichotomous covariates on the response to receiving notifications and because peers with differing covariate values were equally likely to randomly receive any given number of notifications, the impact of any slight non-linearity on estimates of influence and susceptibility must be equal across peers with differing covariate values. Furthermore, the majority of comparison of influence and susceptibility are relative and so will not be affected by overall shifts of influence and susceptibility hazard estimates across all covariates.

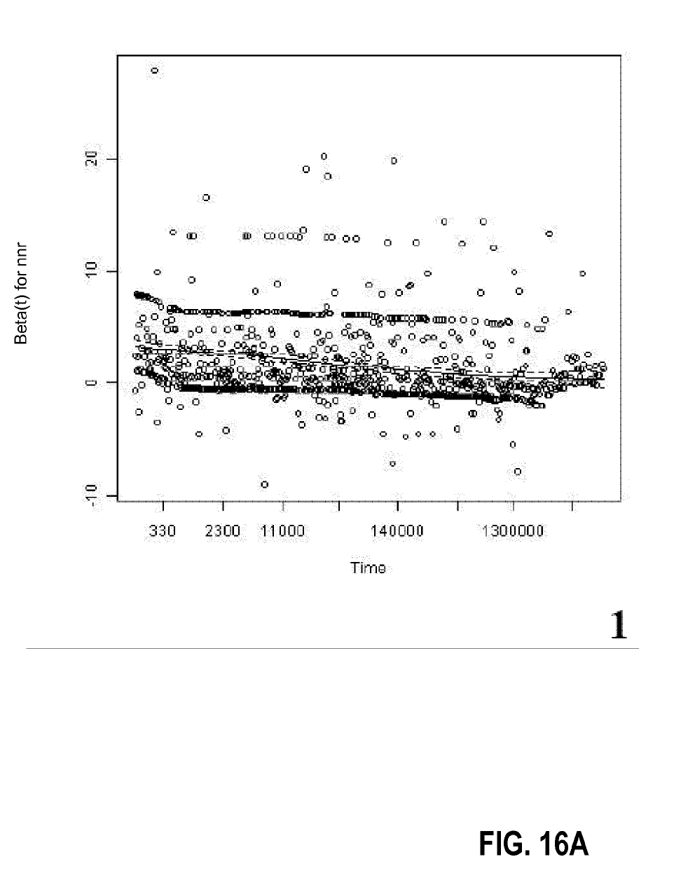

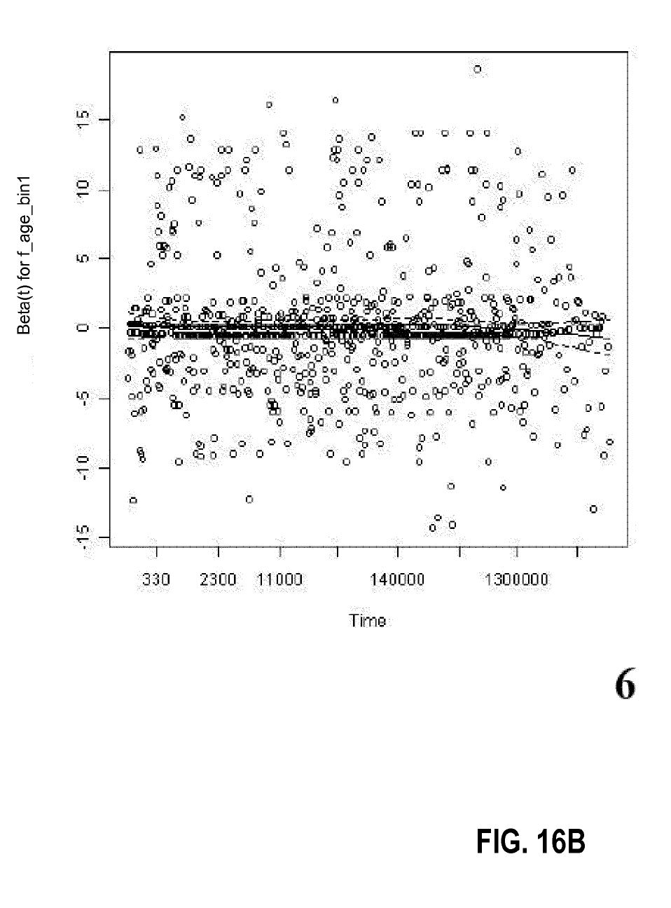

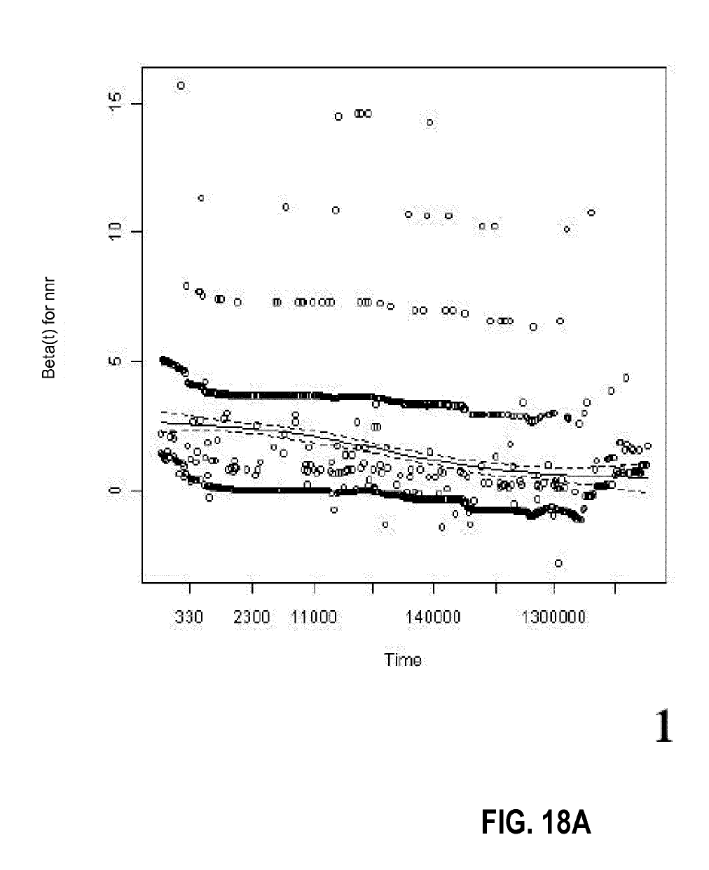

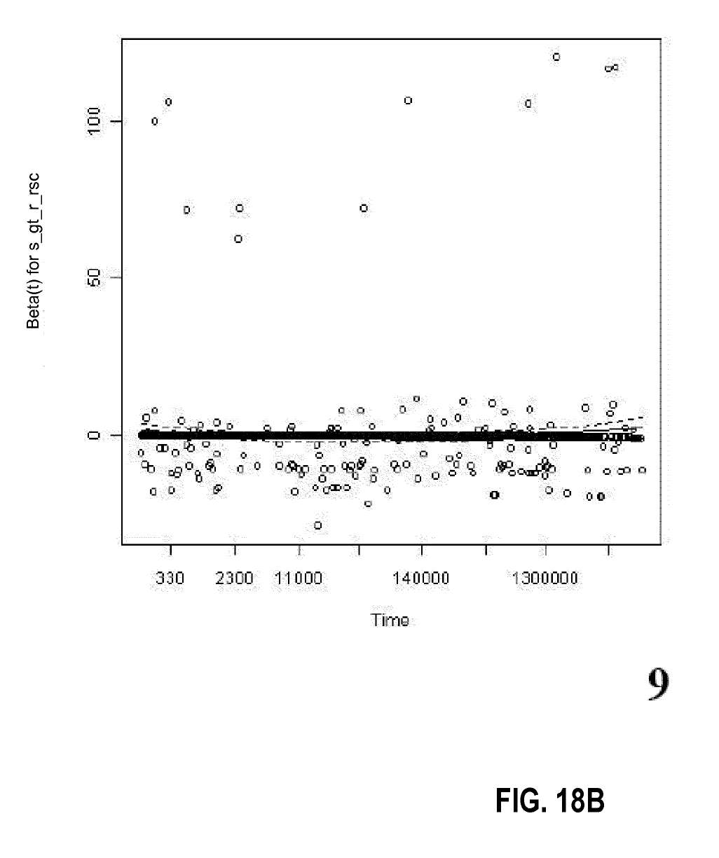

Plots of scaled Schoenfeld residuals associated with model covariates across survival times assess the validity of the proportional hazards assumption. Linear trends in scaled Schoenfeld residuals associated with a particular covariate across survival times indicate that the proportional hazards assumption is violated for that covariate. Scaled Schoenfeld residual plots for representative model covariates of the 45 model covariates in the influence and susceptibility model are displayed in FIGS. 16A and 16B, and for the dyadic peer-to-peer influence model in FIGS. 18A and 18B. There are no significant trends observed, indicating the validity of the proportional hazards assumption.

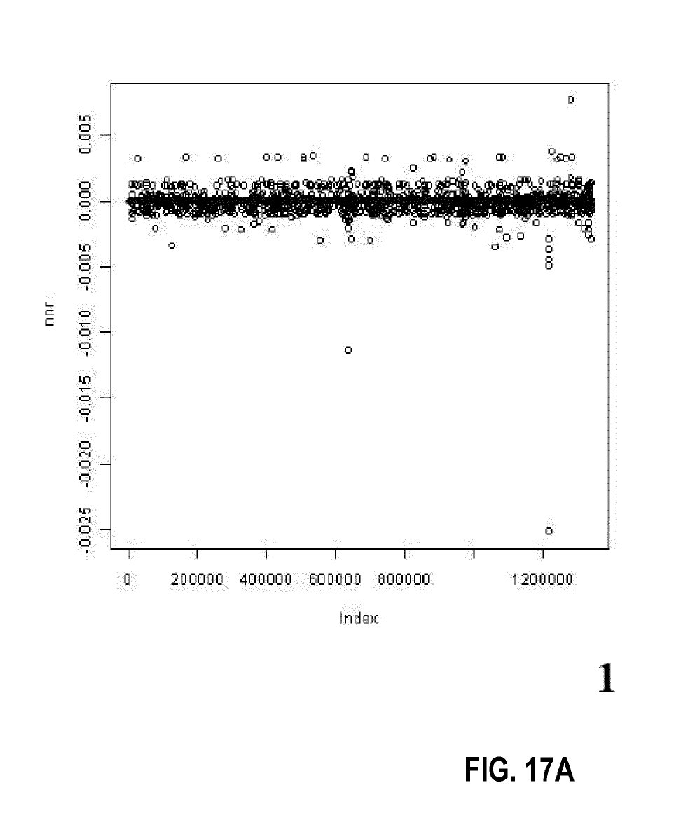

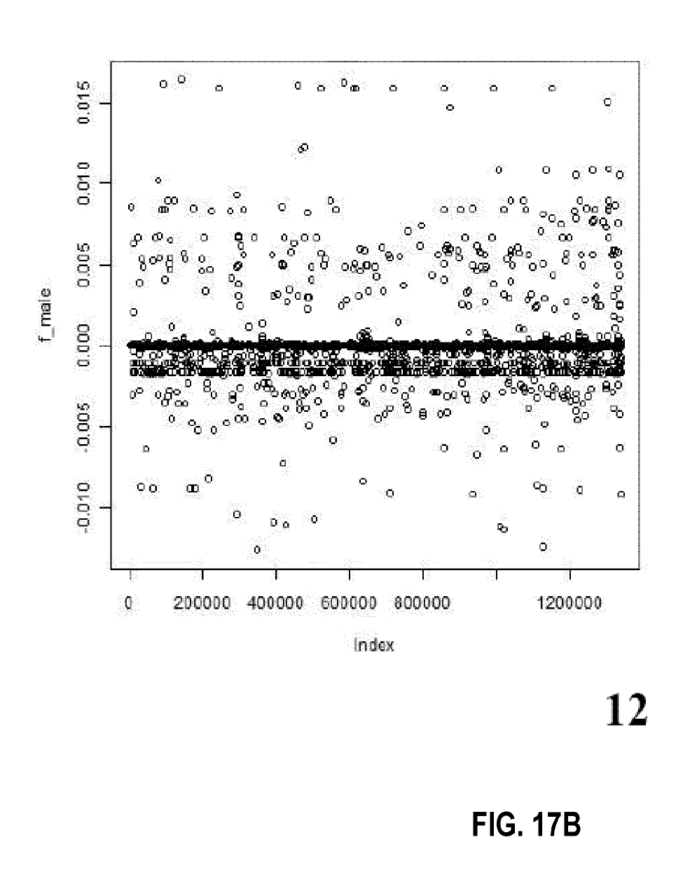

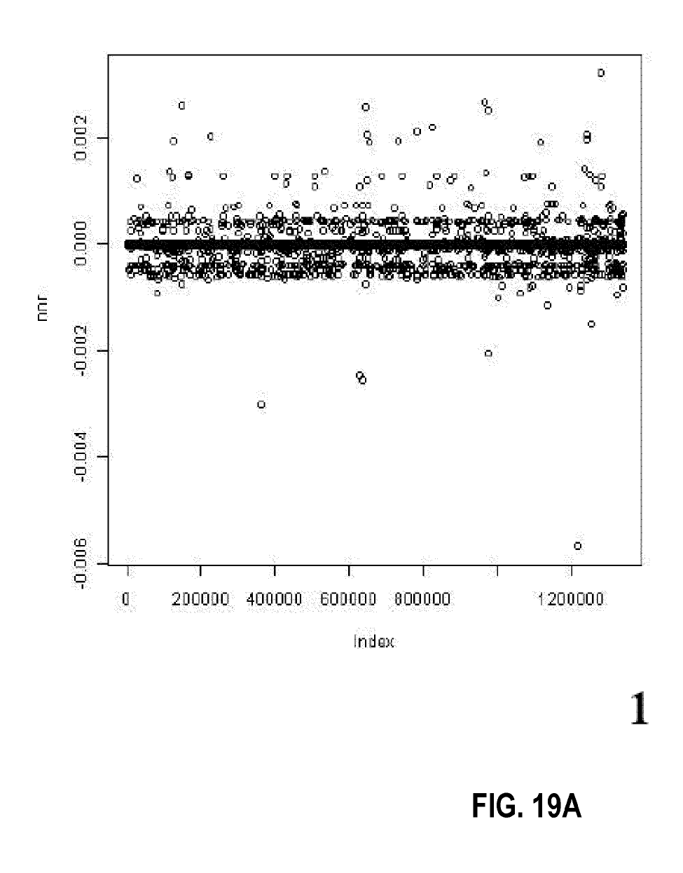

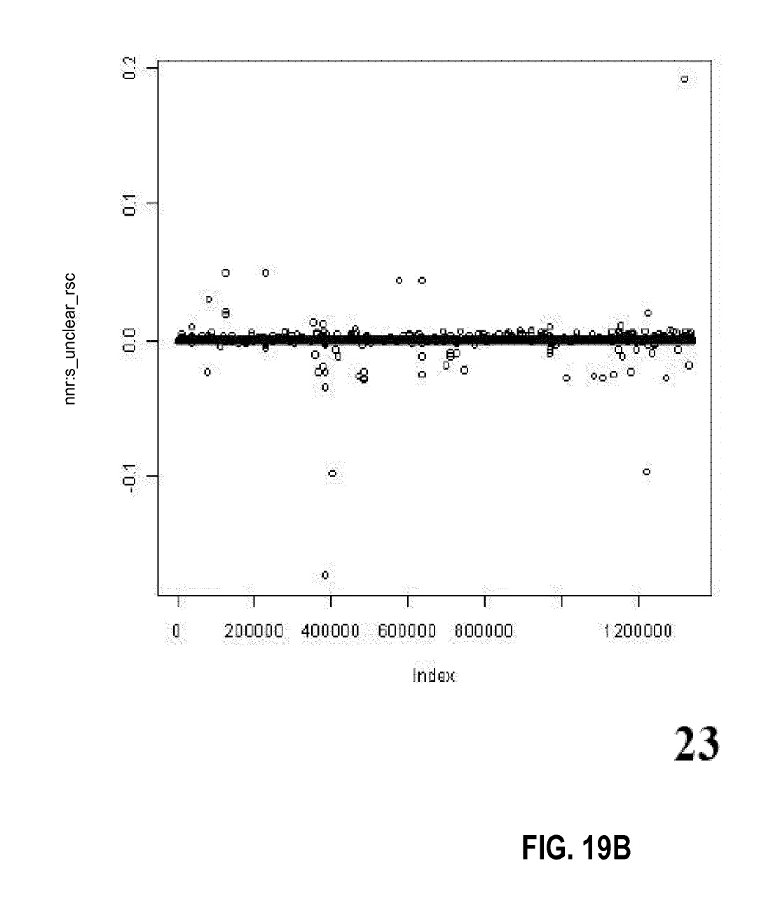

Plots of dfbeta residuals across peer subject for model estimates assess the contribution of a given subject to the fitted estimation (β) (i.e., the relative change in the estimate when a given subject observation is omitted from the data). Plots of dfbeta residuals for representative covariates of the 45 covariates in the influence and susceptibility Cox proportional hazard model and representative covariates of the 23 covariates in the dyadic peer-to-peer influence Cox proportional hazard model are displayed in FIGS. 17A and 17B and FIGS. 19A and 19B, respectively. These plots reveal that, overall, no single observation in the data exert a disproportionate impact on model estimates.

The discussed analysis aggregates individual experiments that take place at the local ego network level. One potential concern in such circumstances is that peers of the same adopting user are not independent, but rather experience common group level shocks to their adoption likelihoods. Heterogeneity across local network neighborhoods can introduce bias if, for example, some adopters have mere affinity for the product and send more messages than others, and if there is homophily in these preferences such that peers of high affinity adopters are more likely as a group to adopt the product than peers of other adopters. Numerous steps were taken to ensure that the results were not biased by group level heterogeneity.

First, the robustness of the estimates where checked to the most likely specific concerns regarding heterogeneity in observable characteristics and behaviors across adopting users. To test the robustness of the results to the concern that some adopters will send more notifications than others, the influence and susceptibility model controlling for the number of notifications sent by adopter i divided by i's degree (which represents the number of notifications peers of i would expect to receive) was estimated. This had no effect on any of the other parameters and was itself not significant. The adopter i's degree and the number of notifications sent by adopter i were separately controlled. None of these specifications changed the results. These results should dispel any concern that heterogeneity in the sending rate of i is affecting the results.

Second, alternative specifications were estimated as robustness checks. However, as explained here, none of the alternative specifications are appropriate for the discussed modeling aims. This discussion highlights the importance of matching model specification choices (and the subsequent interpretation of parameter estimates) to the specific scientific and policy making goals of the analysis. To account for group level heterogeneity and adopter specific effects, an influence and susceptibility model was fit that accounts for observable characteristics of the adopter and estimated a shared frailty (random group effects) specification to control for unobserved heterogeneity. The shared frailty specification models intragroup correlations by introducing an unobservable multiplicative effect on the hazard, so that conditional on the frailty λ(t|α)=αᵢλ(t), where αᵢ is a random positive quantity with mean 1 and variance θ and i indexes the group—in this case the local ego network or the original adopter i. For any member of the ith group the hazard function is multiplied by the shared frailty αᵢ. Thus the influence and susceptibility model was estimated as follows:

λ(t,Xᵢ,Xⱼ,Nⱼ|αᵢ)=αᵢλ₀(t)exp(Nⱼ(t)β_{N}+Xᵢβ_{Spont}ⁱ+Xⱼβ_{Spont}^{j}+Nⱼ(t)Xᵢβ_{Infl}+Nⱼ(t)Xⱼβ_{Susc}).

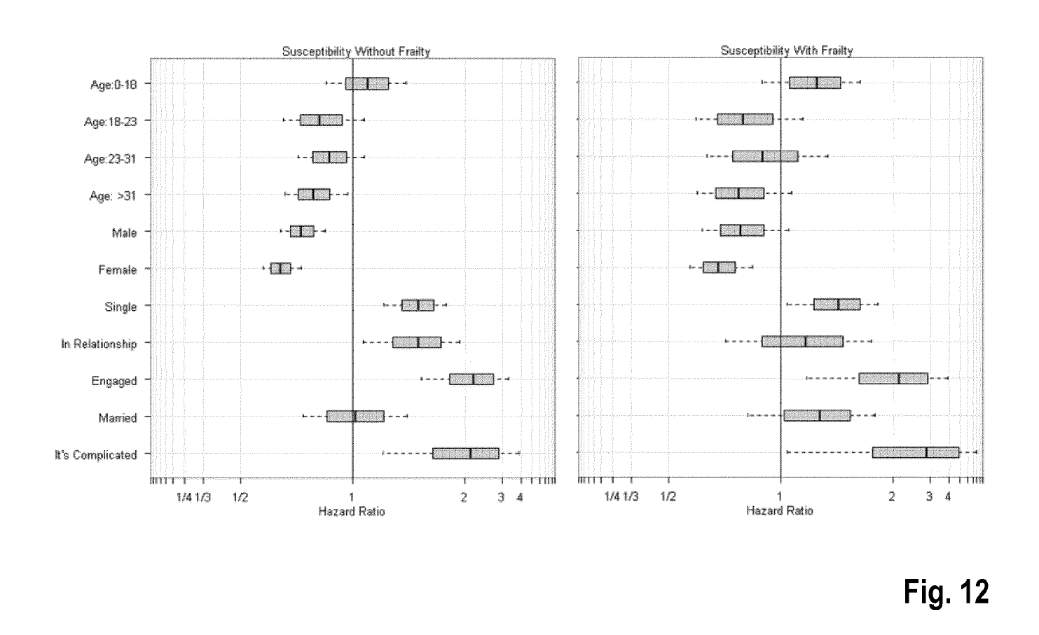

Results of the shared frailty model show that susceptibility estimates are robust to the inclusion of random group effects (as well as to controls for adopters' observable characteristics and the inclusion of covariates for the number of notifications adopters send). FIG. 12 illustrates susceptibility estimates based upon the experimental data in accordance with an illustrative implementation. The susceptibility estimates change somewhat but not substantially as shown in FIG. 12.

The influence terms change slightly more, but frailty specifications are not appropriate when estimating influence in this illustrative case because they model individual frailty with respect to the adopters (the message senders) (see Table A9 for full frailty results). They are not appropriate because there is no interest in estimating the effect of age on influence holding constant all unobservables—if experience is unobservable and creates influence, and if age and experience are correlated, estimating the effect of age net of experience is less interesting, but rather whether age, for whatever reason, predicts influence. The reason this effect is a concern rather than the effect of age net of all unobservables is that the policies intended to inform with this analysis are not improved by understanding the causal effect of an additional year of age on influence, but rather by identifying characteristics of influential people whatever their underlying causes. This is because a government or firm policy targeting “influential” people would not attempt to exogenously change the age, gender or relationship status of a group of people in order to increase their influence, but would rather attempt to identify influential people in order to give them free products or anti-smoking education or some other intervention in the hopes of changing the behavior of their peers. The underlying causal relationship between individual characteristics and the magnitude of influence is not the key to optimizing this policy, but identifying correlates of influence is.

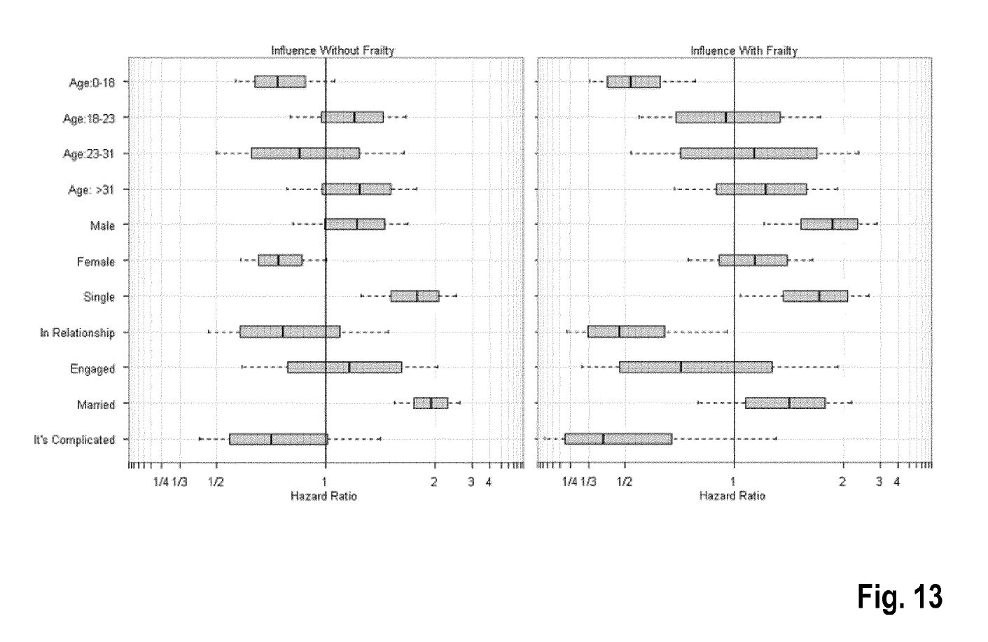

This is not to say that causal inference is not of interest. Establishing the causal effect of peer influence on adoption (while controlling for example for the natural clustering of adoption amongst consumers with correlated preferences) and simultaneously estimating correlates of influence can be interesting, rather than causes of influence, in other words, the characteristics of people who are more influential (e.g. men or women, the young or the old). The randomization procedure helps establish causal influence controlling for the traditional confounds. The influence of an adopter on their peers via influence mediating messages is therefore better modeled by the inclusion of covariates for notifications and notifications moderated by user characteristics in the unified model. FIG. 13 illustrates Dyadic models with and without frailty based upon the experimental data in accordance with an illustrative implementation.

To account for the possibility that peers of the same adopters may not be i.i.d., the standard errors on the senders' local network were clustered. The significance of parameter estimates change only slightly and the results are robust to both clustering and shared frailty, indicating that variance introduced by within-network correlations in peer adoption do not significantly affect the findings. The results reported above use clustered standard errors.

TABLE A9
Estimates from Influence and Susceptibility Cox Proportional
Hazards Model with Frailty

| | | | | | CI | CI |
|---|---|---|---|---|---|---|
| | | | | | Lower | Upper |
| | β | exp(β) | se(β) | Pr(>\|z\|) | .95 | .95 |
| | Treatment (β_{N}) | | | | | |
| # Notifications | 1.867 | 6.472 | 0.066 | 0.000 | 5.684 | 7.369 |
| | Spontaneous Adoption ( βₛₚₒₙₜⁱ) | | | | | |
| Age (0-18) | 0.338 | 1.403 | 0.165 | 0.041 | 1.014 | 1.940 |
| Age (18-23) | −0.389 | 0.678 | 0.234 | 0.096 | 0.429 | 1.072 |
| Age (23-31) | −0.184 | 0.832 | 0.225 | 0.415 | 0.535 | 1.294 |
| Age (>31) | −0.038 | 0.963 | 0.160 | 0.813 | 0.704 | 1.316 |
| Male | −0.085 | 0.919 | 0.172 | 0.620 | 0.656 | 1.286 |
| Female | 0.072 | 1.075 | 0.132 | 0.586 | 0.830 | 1.392 |
| Single | −0.129 | 0.879 | 0.151 | 0.394 | 0.654 | 1.182 |
| Relationship | −0.185 | 0.831 | 0.210 | 0.379 | 0.550 | 1.256 |
| Engaged | −0.330 | 0.719 | 0.414 | 0.426 | 0.319 | 1.619 |
| Married | −0.326 | 0.722 | 0.186 | 0.079 | 0.502 | 1.039 |
| Its Complicated | −0.125 | 0.883 | 0.419 | 0.766 | 0.388 | 2.008 |
| | | | | | CI | CI |
| | | | | | Lower | Upper |
| | β | exp(β) | se(β) | Pr(>\|z\|) | .95 | .95 |
| | Spontaneous Adoption of j (β_{Spont}^{j} ) | | | | | |
| Age (0-18) | 0.105 | 1.111 | 0.151 | 0.487 | 0.826 | 1.493 |
| Age (18-23) | −0.028 | 0.972 | 0.160 | 0.860 | 0.710 | 1.331 |
| Age (23-31) | −0.447 | 0.640 | 0.190 | 0.019 | 0.441 | 0.928 |
| Age (>31) | 0.433 | 1.542 | 0.136 | 0.001 | 1.181 | 2.015 |
| Male | 0.466 | 1.593 | 0.132 | 0.000 | 1.229 | 2.064 |
| Female | 0.894 | 2.444 | 0.112 | 0.000 | 1.961 | 3.046 |
| Single | 0.266 | 1.305 | 0.133 | 0.046 | 1.005 | 1.695 |
| Relationship | −0.107 | 0.899 | 0.189 | 0.571 | 0.621 | 1.301 |
| Engaged | −0.381 | 0.683 | 0.411 | 0.354 | 0.305 | 1.529 |
| Married | 0.310 | 1.363 | 0.162 | 0.056 | 0.992 | 1.873 |
| Its Complicated | −0.633 | 0.531 | 0.641 | 0.324 | 0.151 | 1.866 |
| | Influence ( β_{Infl}) | | | | | |
| Age (0-18) | −0.245 | 0.782 | 0.132 | 0.064 | 0.604 | 1.014 |
| Age (18-23) | 0.139 | 1.149 | 0.154 | 0.366 | 0.850 | 1.553 |
| Age (23-31) | −0.125 | 0.882 | 0.238 | 0.598 | 0.554 | 1.405 |
| Age (>31) | 0.167 | 1.182 | 0.154 | 0.280 | 0.873 | 1.599 |
| Male | 0.154 | 1.166 | 0.140 | 0.271 | 0.887 | 1.534 |
| Female | −0.243 | 0.784 | 0.102 | 0.017 | 0.642 | 0.957 |
| Single | 0.538 | 1.712 | 0.139 | 0.000 | 1.303 | 2.249 |
| Relationship | −0.217 | 0.805 | 0.292 | 0.457 | 0.454 | 1.426 |
| Engaged | 0.115 | 1.121 | 0.345 | 0.740 | 0.570 | 2.207 |
| Married | 0.660 | 1.935 | 0.163 | 0.000 | 1.405 | 2.666 |
| Its Complicated | −0.286 | 0.751 | 0.411 | 0.487 | 0.336 | 1.682 |
| | Susceptibility (β_{Susc}) | | | | | |
| Age (0-18) | 0.072 | 1.074 | 0.109 | 0.510 | 0.868 | 1.330 |
| Age (18-23) | −0.157 | 0.854 | 0.120 | 0.192 | 0.675 | 1.082 |
| Age (23-31) | −0.110 | 0.895 | 0.130 | 0.396 | 0.694 | 1.156 |
| Age (>31) | −0.192 | 0.825 | 0.112 | 0.087 | 0.662 | 1.029 |
| Male | −0.259 | 0.772 | 0.091 | 0.004 | 0.646 | 0.923 |
| Female | −0.388 | 0.678 | 0.071 | 0.000 | 0.590 | 0.780 |
| Single | 0.347 | 1.415 | 0.113 | 0.002 | 1.134 | 1.765 |
| Relationship | 0.349 | 1.417 | 0.171 | 0.042 | 1.013 | 1.983 |
| Engaged | 0.774 | 2.168 | 0.262 | 0.003 | 1.297 | 3.623 |
| Married | 0.014 | 1.014 | 0.147 | 0.925 | 0.759 | 1.354 |
| Its Complicated | 0.748 | 2.112 | 0.405 | 0.065 | 0.955 | 4.672 |

Predicted influence and susceptibility scores for 12 million users of the social network were calculated, based on their individual attributes, using the results from influence and susceptibility models. The predicted influence (susceptibility) score is defined as the product of influence (susceptibility) hazard ratios for the attributes of age, gender and relationship status, as given by:

$${S}_{Infl} = {\prod }_{a} exp ( {β}_{Infl , a} )$$

$$and$$

$${S}_{Susc \backslash} = {\prod }_{a} exp ( {β}_{Susc , a} ) ,$$

where β_{Infl,α}(β_{Susc,α}) is the estimated influence (susceptibility) hazard associated with attribute a. For example, the predicted influence score for a 25 year old single male is given by: S_{Infl}=exp(β_{Infl,Age23-31})×exp(β_{Infl,Male})×exp(β_{Infl,Single}).
This method of calculating predicted influence and susceptibility scores is consistent with the proportional hazards assumption implicit in the Cox models employed in the above analysis.

The contour plots shown in FIGS. 8-11 were generated from predicted data using ridge regression surface modeling, a standard method for smoothing three-dimensional data. The method employs a regularizer proportional to the difference between first partial derivatives in neighboring bins, with the constant of proportionality chosen to be 2.5 to achieve sufficient smoothness. FIG. 8 was generated from the set of unique values of predicted ego influence and ego susceptibility and the corresponding multiplicity for 12M individuals. FIGS. 9-11 were generated from the set of unique values of predicted ego influence (or susceptibility) and peer influence (or susceptibility) for 85M social relationships (edges) between the same 12M individuals.

The discussed experimental results for influence identification presented are generalizable. Various implementations can be used to measure influence and susceptibility in the diffusion of other products and behaviors in a variety of settings where communication and influence can be mediated and outcome responses are measurable, as is the case in a variety of online systems and intervention programs studied in economics and the social sciences. For example, individuals that are influential can be identified. These individuals can include influencers that are connected to other individuals that are highly influential. Once a group of influencers are identified, a message or advertisement can be targeted to these individuals. The message or advertisement can be designed to influence the behavior of the targeted individuals. In addition, because the individuals are influential, they will likely influence their peers. The behavior can include adoption of a program, application, spreading of information, amplifying the message through a network, etc. For example, individuals can be targeted as facilitators of information. As an example, the facilitators of information can help spread a message through a network of people. These people can be targeted to increase the spread of message through the network. In one implementation, the identification of individuals and sending targeted messages/advertisements can be implemented on one or more computing devices.

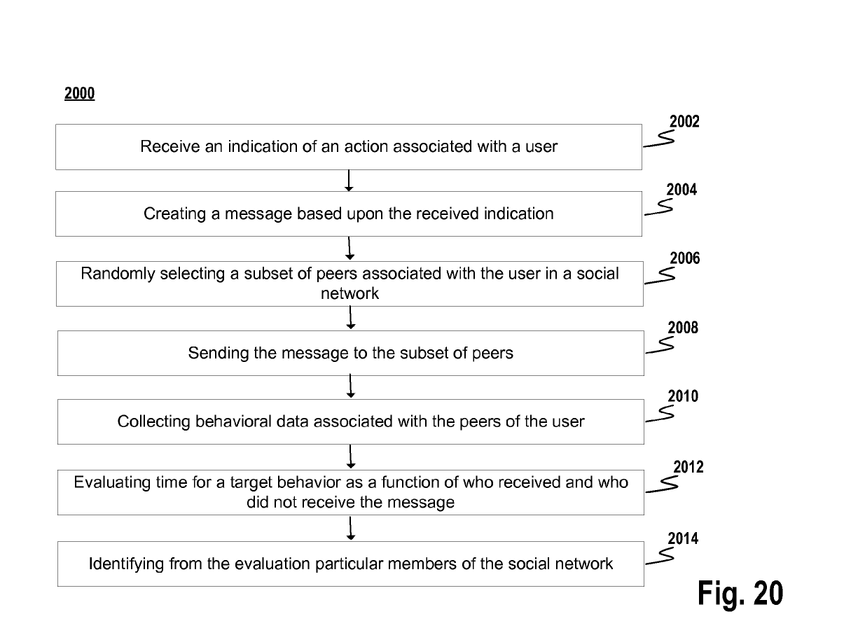

FIG. 20 illustrates a flow diagram of a process for identifying particular members of a social network with an illustrative implementation. The process 2000 can be implemented on a computing device. In one implementation, the process 2000 is encoded on a computer-readable medium that contains instructions that, when executed by a computing device, cause the computing device to perform operations of the process 2000.

The process includes receiving an indication of an action associated with a user (2002). For example, an indication that a user took an action within an application. As a further example, the user can include that a user rated a movie, sent an email, installed an application, sent an instant message, etc. A message can be created based upon the received indication (2004). The message can include details about the indicated event. For example, a message can be contents of an email, an instant message, a notification, etc. The user can be associated with one or more peers in a social network. A subset of these peers can be randomly selected (2006). The message can then be sent to these randomly selected peers (2008). For example, the message can be sent as an email, instant message, notification, etc., to the selected peers. Prior to sending, the message can be tailored for each specific peer. For example, the name of the peer can be inserted into the message. Once the message has been sent, behavioral data associated with users of the social network are collected (2010). For example, data that indicates who sent and who received a particular message. The behavioral data can also include who installed, used, or accessed a particular application, took an action with the social network, or accessed a location within the social network.

Using the collected behavioral data, a time for a targeted behavior as a function of who received and who did not receive the message can be evaluated (2012). For example, the time for a user to access a particular application for a first time can be evaluated. Based at least upon this evaluation, particular members of the social network can be identified (2014). For example, members that have influence over other members can be identified. Various other members can also be identified. For example, individuals that are influential that are also connected to peers that are susceptible to influence can be identified. As another example, individuals that are influential that are also connected to peers that are influential can be identified. In another implementation, once the individuals are identified an advertisement or another message can be sent to the identified individuals. For example, to reduce the number of advertisements sent and increase adoption of a product/service, an advertisement can be sent to an individual that is both influential and connected to peers that are susceptible to influence.

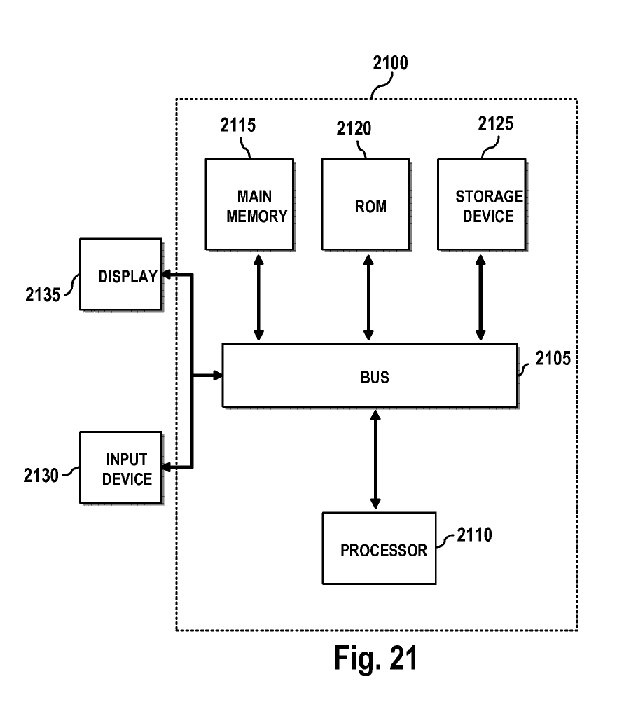

FIG. 21 is a block diagram of a computer system in accordance with an illustrative implementation. The computer system or computing device 2100 can be used to implement a device that implements one or more implementations of the present invention. The computing system 2100 includes a bus 2105 or other communication component for communicating information and a processor 2110 or processing circuit coupled to the bus 2105 for processing information. The computing system 2100 can also include one or more processors 2110 or processing circuits coupled to the bus for processing information. The computing system 2100 also includes main memory 2115, such as a random access memory (RAM) or other dynamic storage device, coupled to the bus 2105 for storing information, and instructions to be executed by the processor 2110. Main memory 2115 can also be used for storing position information, temporary variables, or other intermediate information during execution of instructions by the processor 2110. The computing system 2100 may further include a read only memory (ROM) 2110 or other static storage device coupled to the bus 2105 for storing static information and instructions for the processor 2110. A storage device 2125, such as a solid state device, magnetic disk or optical disk, is coupled to the bus 2105 for persistently storing information and instructions.

The computing system 2100 may be coupled via the bus 2105 to a display 2135, such as a liquid crystal display, or active matrix display, for displaying information to a user. An input device 2130, such as a keyboard including alphanumeric and other keys, may be coupled to the bus 2105 for communicating information and command selections to the processor 2110. In another implementation, the input device 2130 has a touch screen display 2135. The input device 2130 can include a cursor control, such as a mouse, a trackball, or cursor direction keys, for communicating direction information and command selections to the processor 2110 and for controlling cursor movement on the display 2135.

According to various implementations, the processes described herein can be implemented by the computing system 2100 in response to the processor 2110 executing an arrangement of instructions contained in main memory 2115. Such instructions can be read into main memory 2115 from another computer-readable medium, such as the storage device 2125. Execution of the arrangement of instructions contained in main memory 2115 causes the computing system 2100 to perform the illustrative processes described herein. One or more processors in a multi-processing arrangement may also be employed to execute the instructions contained in main memory 2115. In alternative implementations, hard-wired circuitry may be used in place of or in combination with software instructions to effect illustrative implementations. Thus, implementations are not limited to any specific combination of hardware circuitry and software.

Although an example computing system has been described in FIG. 21, implementations of the observer matter and the functional operations described in this specification can be implemented in other types of digital electronic circuitry, or in computer software, firmware, or hardware, including the structures disclosed in this specification and their structural equivalents, or in combinations of one or more of them.

Implementations of the observer matter and the operations described in this specification can be implemented in digital electronic circuitry, or in computer software, firmware, or hardware, including the structures disclosed in this specification and their structural equivalents, or in combinations of one or more of them. The observer matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the observer matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the observer matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
generating, using a processor, a message associated with a user, wherein the user is associated with a plurality of peers in a social network;
randomly selecting a subset of peers from the plurality of peers;
sending the message to the subset of peers;
collecting data pertaining to one or more behaviors from one or more peers of the plurality of peers;
evaluating time for a target behavior as a function of who received the message and who did not receive the message; and
identifying, from the evaluation, particular members of the social network.

2. The method of claim 1, further comprising:
selecting targeted recipients based upon the identification of particular members of the social network; and
sending a second message to each of the targeted recipients.

3. The method of claim 2, wherein the message is an advertisement.

4. The method of claim 1, wherein the particular members meet or exceed a measure of influence.

5. The method of claim 1, wherein the particular members meet or exceed a measure of susceptibility to influence.

6. The method of claim 1, wherein the particular members meet or exceed a particular measure of a likelihood of influence to flow from one member to another member.

7. The method of claim 1, wherein the message is an influence mediating message.

8. The method of claim 1, wherein the identification is unbiased relative to selection bias.

9. The method of claim 1, wherein the identification is unbiased relative to homophily.

10. The method of claim 1, wherein the targeted behavior comprises spontaneous adoption.

11. The method of claim 1, wherein the targeted behavior comprises influence-driven adoption.

12. The method of claim 1, further comprising estimating a moderating effect of individual attributes.

13. The method of claim 1, further comprising estimating an effect of an attribute of a peer on their susceptibility to influence.

14. The method of claim 1, further comprising estimating an effect of dyadic relationships between attributes of a sender and attributes of a recipient on the likelihood of the sender influencing the recipient to adopt.

15. The method of claim 1, wherein a hazard model is employed for the evaluation.

16. The method of claim 15, further comprising comparing spontaneous adoption hazards and influenced adoption hazards to determine a role different individuals play in the diffusion of the target behavior in the social network.

17. The method of claim 1, further comprising determining the effects of observable characteristics of a peer on influence and susceptibility to influence.

18. The method of claim 17, wherein the observable characteristics comprise age, gender, and relationship status.

19. The method of claim 1, wherein identifying from the evaluation particular members of the social network comprises identifying members that meet or exceed a first particular measure of influence, wherein each member is associated with one or more peers that meet or exceed a second particular measure of influence.

20. The method of claim 1, wherein identifying from the evaluation particular members of the social network comprises indentifying members that meet or exceed a first particular measure of influence, wherein each member is associated with one or more peers that meet or exceed a second particular measure of susceptibility to influence.

21. The method of claim 1, wherein the subset of peers is a proper subset of peers from the plurality of peers.

22. A non-transitory computer-readable medium having instructions stored thereon, the instructions comprising:
instructions for generating a message associated with a user, wherein the user is associated with a plurality of peers in a social network;
instructions for randomly selecting a subset of peers from the plurality of peers;
instructions for sending the message to the subset of peers;
instructions for collecting data pertaining to one or more behaviors from one or more peers of the plurality of peers;
instructions for evaluating time for a target behavior as a function of who received the message and who did not receive the message; and
instructions for identifying, from the evaluation, particular members of the social network.

23. The non-transitory computer-readable medium of claim 22, wherein the instructions further comprise:
instructions to select targeted recipients based upon the identification of particular members of the social network; and
instructions to send a second message to each of the targeted recipients.

24. The non-transitory computer-readable medium of claim 22, wherein a hazard model is employed for the evaluation.

25. The non-transitory computer-readable medium of claim 24, wherein the instructions further comprise instructions to compare spontaneous adoption hazards and influenced adoption hazards to determine a role different individuals play in the diffusion of the target behavior in the social network.

26. A system comprising:
one or more processors, configured to:
generate a message associated with a user, wherein the user is associated with a plurality of peers in a social network;
randomly select a subset of peers from the plurality of peers;
send the message to the subset of peers;
collect data pertaining to one or more behaviors from one or more peers of the plurality of peers;
evaluate time for a target behavior as a function of who received the message and who did not receive the message; and
identify, from the evaluation, particular members of the social network.

27. The system of claim 26, wherein the one or more processors are further configured to:
select targeted recipients based upon the identification of particular members of the social network; and
send a second message to each of the targeted recipients.

28. The system of claim 26, wherein a hazard model is employed for the evaluation.

29. The system of claim 28, wherein the one or more processors are further configured to compare spontaneous adoption hazards and influenced adoption hazards to determine a role different individuals play in the diffusion of the target behavior in the social network.
